(19) United States
(12) Patent Application Publication
(10) Pub. No.: US 2025/0321245 A1
(43) Pub. Date: Oct. 16, 2025

(54) SCANNING PROBE SYSTEMS AND FEEDBACK CONTROL METHODS BASED ON DERIVATIVE TUNNELING SIGNAL REGULATION

(71) Applicant: Board of Regents, The University of Texas System, Austin, TX (US)

(72) Inventors: Seyed Omid Reza Moheimani, Allen, TX (US); Richa Mishra, Dallas, TX (US)

(21) Appl. No.: 19/098,514

(22) Filed: Apr. 2, 2025

Related U.S. Application Data
(60) Provisional application No. 63/632,453, filed on Apr. 10, 2024.
(60) Provisional application No. 63/708,811, filed on Oct. 18, 2024.

(51) Int. Cl. G01Q 10/06; G01Q 60/16

(52) U.S. Cl. CPC G01Q 10/065; G01Q 60/16

(57) ABSTRACT

Scanning probe systems and control methods are disclosed in which probe-sample separation is dynamically regulated based on a derivative of a tunneling signal. In some cases, a modulation signal is applied to a control signal associated with an actuator configured to adjust a probe relative to a surface. A tunneling current induced between the probe and the surface is converted into a tunneling signal, from which a derivative signal is obtained based at least in part on the modulation. A feedback processor determines a control metric based on the derivative signal and adjusts the control signal to maintain the control metric substantially constant during scanning. In some implementations, the derivative signal is proportional to a natural logarithm of a transimpedance-scaled rate of change of tunneling current with respect to probe-surface separation. Multi-tip configurations and lock-in amplifier-based demodulation are also described. Some disclosed techniques facilitate enhanced probe control and topography imaging performance in scanning tunneling microscopy and related systems.

### RELATED APPLICATIONS

This application claims the benefit of U.S. Provisional Patent Application No. 63/708,811, filed Oct. 18, 2014, entitled Scanning Tunneling Microscope Controlled with Out-of-Bandwidth Frequency Components, and U.S. Provisional Patent Application No. 63/632,453, filed Apr. 10, 2014, entitled Scanning Tunneling Microscope Controlled with Out-of-Bandwidth Frequency Components, the disclosure of each of which is hereby incorporated herein by reference in its entirety for all purposes. Any and all applications for which a domestic priority claim is identified in the Application Data Sheet of the present application are hereby incorporated by reference under 37 CFR 1.57.

### STATEMENT OF GOVERNMENT INTEREST

This invention was made with government support under Contract no. DE-SC0020827 awarded by the Department of Energy. The government has certain rights in the invention.

### FIELD

The present disclosure generally relates to scanning probe microscopy and, more particularly, to feedback control systems and methods for regulating probe-sample separation in response to derivative tunneling signal characteristics.

### BACKGROUND

Scanning probe microscopy techniques, such as scanning tunneling microscopy (STM), have been explored for use in characterizing surfaces with fine spatial resolution. These systems often rely on the establishment of a tunneling current between a conductive probe and a sample surface positioned in close proximity, typically under a controlled bias voltage. In some cases, closed-loop feedback mechanisms may be employed to regulate the vertical position of the probe based at least in part on the measured tunneling current. Certain implementations have incorporated modulation-based techniques and signal demodulation components, which may support the extraction of additional surface-dependent parameters beyond basic topographic information. Various factors, including mechanical stability, electronic noise, and variations in surface or tip conditions, have at times presented challenges for achieving consistent measurement performance or maintaining desired resolution characteristics across different operational contexts.

### SUMMARY

Certain illustrative examples are described in the following numbered clauses:

Clause 1. A scanning probe system comprising:
a probe configured to establish a tunneling current with a surface in response to a bias voltage applied between the probe and the surface;
an actuator configured to adjust a separation between the probe and the surface;
a controller configured to generate a control signal for the actuator;
a modulation generator configured to apply a modulation signal to the control signal;
a current sensing circuit configured to produce a tunneling signal representative of the tunneling current;
a demodulation circuit configured to extract a derivative signal based at least in part on the tunneling signal and the modulation signal, wherein the derivative signal corresponds to a time-varying component indicative of a rate of change of the tunneling current with respect to a separation between the probe and the surface;
a feedback processor configured to compute a control metric based at least in part on the derivative signal;
wherein the controller is configured to update the control signal based at least in part on a difference between the control metric and a defined setpoint;
wherein the control signal is configured to regulate the separation between the probe and the surface such that the control metric remains substantially constant during scanning.

Clause 2. The system of Clause 1, wherein the derivative signal comprises a signal representative of a natural logarithm of a product of a transimpedance gain and a derivative of the tunneling current with respect to the separation between the probe and the surface.

Clause 3. The system of any of the preceding clauses, wherein the modulation generator is configured to apply a sinusoidal modulation to the control signal at a frequency selected to be outside a control bandwidth associated with the feedback processor.

Clause 4. The system of any of the preceding clauses, wherein the demodulation circuit comprises a lock-in amplifier configured to extract a frequency component of the tunneling signal corresponding to the modulation signal.

Clause 5. The system of any of the preceding clauses, wherein the feedback processor comprises a proportional-integral controller configured to generate the control signal based on an error between the control metric and the defined setpoint.

Clause 6. The system of any of the preceding clauses, wherein the current sensing circuit comprises a transimpedance amplifier configured to convert the tunneling current into a voltage signal prior to demodulation.

Clause 7. The system of any of the preceding clauses, wherein the feedback processor is configured to compute the control metric based on a magnitude of the derivative signal.

Clause 8. The system of any of the preceding clauses, wherein the probe is configured to be rastered along a lateral scanning path while the actuator adjusts the separation between the probe and the surface based on the control signal.

Clause 9. The system of any of the preceding clauses, wherein the probe comprises a single probe, the actuator comprises a single actuator configured to vertically displace the probe relative to the surface, and the controller is further configured to raster the probe laterally across the surface during scanning, wherein the control signal is used to generate a topography signal based at least in part on regulation of the separation between the probe and the surface.

Clause 10. The system of any of the preceding clauses, wherein:
the probe comprises a plurality of probes, each configured to establish a respective tunneling current with the surface;
the actuator comprises a plurality of actuators, each configured to adjust a respective separation between the probe and the surface;
the controller comprises a plurality of controllers, each configured to generate a respective control signal for a corresponding actuator;
the modulation generator comprises a plurality of modulation generators, each configured to apply a modulation signal at a distinct frequency to a respective control signal;
the current sensing circuit is configured to receive a combined tunneling current from the plurality of probes; and
the demodulation circuit comprises a plurality of lock-in amplifiers, each configured to extract a respective derivative signal associated with a corresponding modulation frequency; and
the feedback processor comprises a plurality of feedback processors, each configured to compute a respective control metric based on the respective derivative signal and update the respective control signal based at least in part on a difference between the control metric and a corresponding defined setpoint.

Clause 11. A method for operating a scanning probe system, the method comprising:
applying a modulation signal to a control signal associated with an actuator configured to adjust a separation between a probe and a surface, wherein the modulation signal induces a displacement of the probe relative to the surface;
generating a tunneling signal representative of a tunneling current induced between the probe and the surface, the tunneling current being responsive to probe displacement resulting from application of the modulation signal;
obtaining a derivative signal based at least in part on the tunneling signal and the modulation signal, wherein the derivative signal is indicative of a rate of change of the tunneling current with respect to the separation between the probe and the surface;
determining a feedback metric based at least in part on the derivative signal; and adjusting the control signal based at least in part on a difference between the feedback metric and a reference value.

Clause 12. The method of Clause 11, wherein the control signal regulates the separation between the probe and the surface such that the feedback metric remains substantially constant during scanning.

Clause 13. The method of Clause 11, wherein the modulation signal comprises a sinusoidal waveform applied at a frequency selected to be greater than a closed-loop control bandwidth of the scanning probe system and less than a mechanical resonance frequency associated with the actuator.

Clause 14. The method of Clause 11, wherein generating the tunneling signal comprises amplifying the tunneling current using a transimpedance amplifier to convert the tunneling current into a voltage signal prior to obtaining the derivative signal.

Clause 15. The method of Clause 11, wherein obtaining the derivative signal comprises:
demodulating the tunneling signal at a frequency of the modulation signal using a lock-in amplifier; and
extracting an amplitude component representative of the rate of change of the tunneling current with respect to the separation between the probe and the surface.

Clause 16. The method of Clause 11, wherein determining the feedback metric comprises applying a natural logarithm to a product of a transimpedance gain and the derivative signal, wherein the feedback metric is proportional to 1n(Rdi/dz), where R is the transimpedance gain and di/dz is a derivative of the tunneling current with respect to the separation between the probe and the surface.

Clause 17. The method of clause 11, wherein the feedback metric is proportional to a rate of change of the tunneling current with respect to the separation between the probe and the surface.

Clause 18. The method of Clause 11, wherein adjusting the control signal comprises:
generating an error signal based on a difference between the feedback metric and the reference value; and
applying a proportional-integral controller to generate the adjusted control signal based on the error signal.

Clause 19. The method of Clause 11, further comprising raster scanning the probe along a defined lateral path while maintaining the control signal such that the separation between the probe and the surface varies to preserve the feedback metric at or near the reference value.

Clause 20. The method of Clause 11, wherein the scanning probe system comprises a plurality of probes, and the method further comprises:
applying distinct modulation signals at different respective frequencies to a corresponding set of control signals associated with actuators for each of the plurality of probes;
independently generating, for each of the plurality of probes, a tunneling signal and a corresponding derivative signal;
independently determining a feedback metric for each of the plurality of probes based on the corresponding derivative signal; and
   independently adjusting each control signal based on a respective difference between the corresponding feedback metric and a reference value.

Clause 21. The method of Clause 11, wherein the scanning probe system comprises a single probe, and the method further comprises:
combining the control signal and the modulation signal to form a composite signal;
applying the composite signal to a piezoelectric actuator to induce tip displacement; and
generating a topography image of the surface based at least in part on variations in the control signal during a raster scan of the probe.

### BRIEF DESCRIPTION OF THE DRAWINGS

Throughout the drawings, reference numbers can be re-used to indicate correspondence between referenced elements. The drawings are provided to illustrate embodiments of the present disclosure and do not to limit the scope thereof.

FIG. 1 illustrates an example feedback control system for STM.

FIG. 2A illustrates a topography image of a sample surface acquired using a STM feedback loop operating in a constant-current mode.

FIG. 2B illustrates a surface height profile corresponding to the topography image shown in FIG. 2A.

FIG. 2C illustrates a topography image of the sample surface shown in FIG. 2A, acquired using a STM feedback loop operating in a constant-di/dz mode.

FIG. 2D illustrates a surface height profile corresponding to the topography image shown in FIG. 2C.

FIG. 3A illustrates a topography image of a sample surface following lithography performed using a STM feedback loop operating in a constant-current mode.

FIG. 3B illustrates a surface height profile corresponding to the topography image shown in FIG. 3A.

FIG. 3C illustrates a topography image of the sample surface shown in FIG. 3A, acquired using a STM feedback loop operating in a constant-di/dz mode.

FIG. 3D illustrates a surface height profile corresponding to the topography image shown in FIG. 3C.

FIG. 4A illustrates a topography image of a sample surface acquired using a STM feedback loop operating in a constant-di/dz mode.

FIG. 4B illustrates a surface height profile corresponding to the topography image shown in FIG. 4A.

FIG. 4C illustrates a topography image of the sample surface shown in FIG. 4A, acquired using a STM feedback loop operating in a constant-current mode.

FIG. 4D illustrates a surface height profile corresponding to the topography image shown in FIG. 4C.

FIG. 4E illustrates a topography image of the sample surface shown in FIG. 4A, acquired using a STM feedback loop operating again in a constant-di/dz mode.

FIG. 4F illustrates a surface height profile corresponding to the topography image shown in FIG. 4E.

FIG. 5A illustrates a topography image of a sample surface acquired using a STM feedback loop operating in a constant-di/dz mode.

FIG. 5B illustrates a topography image of the sample surface shown in FIG. 5A after spiral lithography is performed using the same constant-di/dz feedback mode.

FIG. 6A illustrates a topography image of a sample surface acquired using a STM feedback loop operating in a constant-current mode after lithography.

FIG. 6B illustrates a surface height profile corresponding to the topography image shown in FIG. 6A.

FIG. 6C illustrates a topography image of the sample surface shown in FIG. 6A, acquired using a STM feedback loop operating in a constant-di/dz mode.

FIG. 6D illustrates a surface height profile corresponding to the topography image shown in FIG. 6C.

FIG. 7A illustrates a topography image of a sample surface after spiral lithography is performed using a STM feedback loop operating in a constant-current mode.

FIG. 7B illustrates a surface height profile corresponding to the topography image shown in FIG. 7A.

FIG. 7C illustrates a topography image of the sample surface shown in FIG. 7A, acquired using a STM feedback loop operating in a constant-di/dz mode.

FIG. 7D illustrates a surface height profile corresponding to the topography image shown in FIG. 7C.

FIG. 8A illustrates a topography image of a sample surface acquired using a STM feedback loop operating in a constant-current mode.

FIG. 8B illustrates a surface height profile corresponding to the topography image shown in FIG. 8A.

FIG. 8C illustrates a topography image of the sample surface shown in FIG. 8A, acquired using a STM feedback loop operating in a constant-di/dz mode.

FIG. 8D illustrates a surface height profile corresponding to the topography image shown in FIG. 8C.

FIG. 9 illustrates an example STM system operating in a constant current mode (CCM).

FIG. 10 illustrates an example block diagram for a CCM STM feedback control system.

FIG. 11 illustrates an example block diagram of a lock-in amplifier (LIA) system that can be used to extract amplitude and phase information from an input signal.

FIG. 12 illustrates an example block diagram of a STM operating in a constant di/dz feedback mode.

FIG. 13 illustrates an example control block diagram of the z-axis of a STM operating in a constant di/dz feedback mode.

FIGS. 14A-14D illustrate surface property maps and signal profiles acquired simultaneously using constant-current STM imaging.

FIG. 15 illustrates an example control block diagram configured for model discovery of an STM system operating under 1n(Rdi/dz) feedback.

FIGS. 16A and 16B illustrate example frequency response plots used to evaluate the STM system model derived from the configuration shown in FIG. 15.

FIG. 17 illustrates an example design space for selecting proportional-integral (PI) controller parameters ki and ωc for use in the 1n(R di/dz) feedback loop.

FIG. 18 shows open-loop frequency responses of the STM system operating in constant 1n(R·di/dz) feedback mode.

FIG. 19 presents experimental measurements comparing feedback performance in conventional constant-current and di/dz-based control modes.

FIGS. 20A and 20B present a comparative analysis of images acquired using conventional constant 1n(Ri) feedback and constant 1n(Rdi/dz) feedback under similar experimental conditions.

FIG. 20C illustrates Profile 1 extracted from the imaging regions shown in FIGS. 20A and 20B, comparing topography data acquired using conventional 1n(Ri) feedback and 1n(Rdi/dz) feedback under similar conditions.

FIGS. 21A-21C illustrate a comparative evaluation of STM imaging under conditions that may include tip instability or surface feature variability.

FIGS. 22A-22D illustrate comparative imaging results acquired using two different STM feedback strategies.

FIGS. 23A and 23B illustrate an example of spiral lithography performed using constant 1n(Rdi/dz) feedback control.

FIGS. 24A-24C present example image data from repeated scans of a lithographically patterned region acquired under different feedback configurations.

FIG. 24D illustrates Profile 1 extracted from each of the three image sets shown in FIGS. 24A-24C.

FIGS. 25A-25F illustrate comparative imaging results acquired while transitioning between a feedback control loop closed on 1n(Ri) and a feedback control loop closed on 1n(Rdi/dz), under consistent tip and sample conditions.

FIG. 26 illustrates an example STM system configured to operate under feedback control based on a logarithmic differential tunneling signal, in accordance with certain embodiments.

FIG. 27 illustrates an example single-tip STM system configured to operate under di/dz-based feedback control.

FIG. 28 illustrates an example multi-tip STM system configured to perform parallel scanning using multiple STM tips and under respective di/dz-based feedback control.

### DETAILED DESCRIPTION

Scanning tunneling microscopy (STM) systems are often used in atomic-scale imaging and nanofabrication. These systems can regulate the probe-sample separation using a feedback control loop that maintains a constant tunneling current between a conductive tip and a sample surface. However, conventional control modes that rely on current regulation can be sensitive to variations in sample conductivity, tip geometry, or other electronic surface properties, which may degrade imaging fidelity or introduce instability during scanning or lithography operations. In addition, limitations in disturbance rejection and spatial resolution can constrain performance in challenging or variable environments.

Some inventive concepts described herein relate to a scanning probe feedback control technique in which the derivative of the tunneling current with respect to probe height, di/dz, is extracted and used to regulate tip-sample separation. In some cases, the feedback loop operates on a logarithmic derivative signal, such as 1n(R·di/dz), where R is the transimpedance gain. This derivative-based control metric may be obtained through superimposing a high-frequency modulation on the actuator command and demodulating the resulting current using a lock-in amplifier. Regulating this signal enables the probe to maintain a consistent response to surface height variation while suppressing sensitivity to abrupt changes in electronic properties.

Some inventive concepts described herein relate to systems and methods for controlling tunneling current derivatives using modulation-based extraction and proportional-integral (PI) feedback. The control loop can maintain 1n(R·di/dz) at a constant value during scanning, thereby achieving enhanced vertical resolution and improved disturbance rejection. For example, surface conductivity and local barrier height (LBH) often exhibit inverse spatial variation. As a result, fluctuations in electronic output disturbances are moderated under 1n(R·di/dz) control, which can contribute to greater tip stability and more consistent tracking of surface features in comparison to conventional 1n(i)-based feedback.

Some inventive concepts described herein may support flexible system architectures. In some cases, scanning probe platforms may include multiple tips, each operating under an independently closed feedback loop that regulates a respective 1n(R·di/dz) signal. Distinct modulation frequencies may be assigned to each tip, and the system may employ a shared preamplifier with signal demultiplexing to support multi-channel operation. Such configurations can enable scalable lithography and imaging using parallel probe arrays, including for MEMS-based high-throughput STM platforms.

Some inventive concepts described herein may be used with signal processing and controller tuning strategies to enhance performance across a range of operating conditions. For example, experimental system identification methods may be applied to derive an open-loop model of the STM system, and frequency-domain responses may be used to define a design space for selecting PI controller parameters (e.g., integrator gain and corner frequency). These parameters can be chosen to satisfy bandwidth, gain margin, and stability constraints. Low-pass filter settings in the lock-in amplifier may further be tuned to improve signal-to-noise ratio while avoiding excitation of mechanical resonances.

Some inventive concepts described herein may facilitate improved imaging resolution and lithographic precision, including enhanced dimer-row contrast and tip stability across diverse surface types and conditions. Imaging conducted under 1n(R·di/dz) feedback often demonstrates sharper feature delineation, reduced electronic disturbance influence, and greater peak-to-valley modulation in topographic profiles. Lithography under this control mode may support atomic-scale patterning with repeatable spacing and edge fidelity, which is advantageous for hydrogen depassivation lithography and related nanoscale fabrication processes.

By regulating a logarithmic tunneling derivative signal rather than conventional current, the described scanning probe systems and methods may improve sensitivity to vertical surface variation, increase robustness to electronic property changes, and support scalable control implementations. Feedback systems configured in this manner may preserve imaging fidelity while operating at increased tip-sample distance, thus reducing tip wear and minimizing risk of mechanical instability. The resulting advantages may enhance imaging and fabrication throughput, reproducibility, and precision in STM and related scanning probe microscopy platforms.

### STM Feedback Control Using Differential Tunneling Parameters

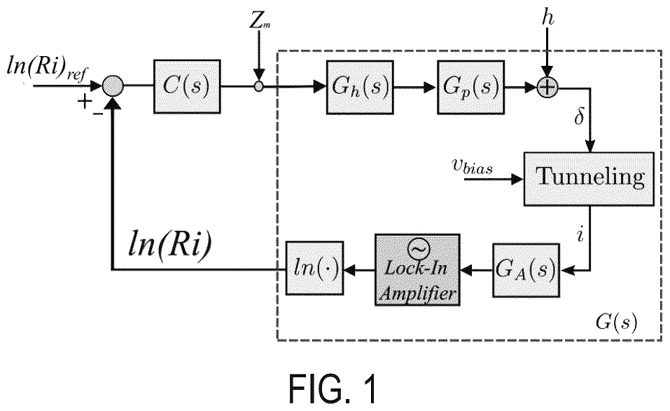

Some inventive concepts described herein relate to feedback control methods for STM, including applications in surface imaging and nanolithography. In particular, the tip-sample distance can be regulated using a feedback loop configured to maintain a substantially constant value of a differential tunneling parameter, such as di/dz, throughout a scan. A representative system architecture for this control approach is shown in FIG. 1.

A simplified model of the tunneling current i can be expressed as:

$$i = f ( σ , {V}_{b} ) {e}^{- 1.1025 \sqrt{φ} z} \qquad ( 1 )$$

The first derivative of i in (1) for z is expressed as:

$$\frac{d i}{d z} = - \sqrt{φ} f ( σ , {V}_{b} ) {e}^{- 1.025 \sqrt{φ} z} \qquad ( 2 )$$

In some cases, an image representing di/dz can be acquired simultaneously with a conventional topography image using modulation-based detection. This may include superimposing a sinusoidal modulation signal onto the controller output and measuring the amplitude of the resulting AC tunneling current at the modulation frequency.

FIG. 1 illustrates a control block diagram of the z-axis of an STM operating in a mode that regulates constant di/dz. A modulation signal is applied to the controller output. The command signal is amplified by a high-voltage amplifier Gₕ, which drives a piezoelectric actuator Gₚ. The differential parameter di/dz can undergo momentary changes when the tip encounters surface features such as height deviations h, and such changes are corrected by the controller C(s) by adjusting the tip-sample distance z, represented as delta. A preamplifier GA(s) converts the sub-nanometer-scale tunneling signal to a measurable voltage, which is passed through a lock-in amplifier to obtain the value of di/dz.

Experimental implementation of this method was performed using a custom-built ultrahigh-vacuum (UHV) STM operating at room temperature, with a base pressure of approximately 1e⁻¹¹ Torr. Feedback and real-time control operations were executed using a ZyVector 20-bit digital controller. Tunneling current measurements were acquired using a Femto DLPCA-200 low-noise preamplifier (gain: 1e⁹; bandwidth: 1 kHz). Experiments on Si(100)−2×1:H surfaces demonstrated the feasibility of regulating feedback based on 1n(di/dz), enabling a novel mode of STM operation.

In this configuration, a sinusoidal modulation signal with frequency ω and amplitude zₘ is added to the controller output. The resulting modulated current is amplified and measured using a lock-in amplifier, which isolates the amplitude of the current component at frequency ω. The feedback error is defined as the difference between a setpoint and the logarithm of the lock-in output. A proportional-integral (PI) controller reduces or minimizes this error to regulate the tip-sample distance. The controller output is then mapped to tip x-y scan positions to construct the topography image.

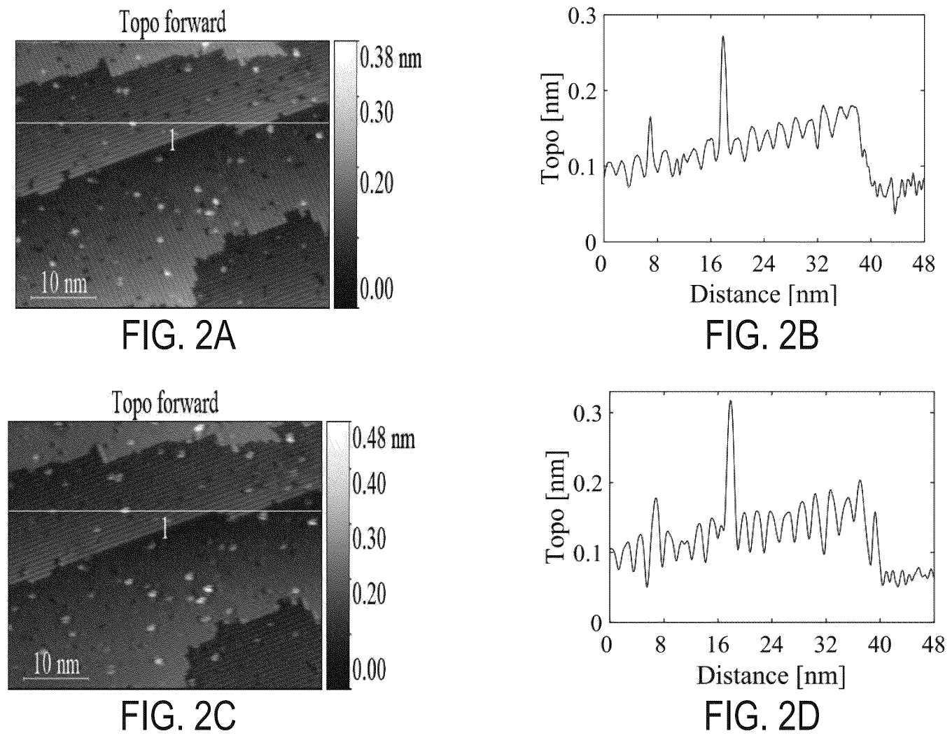

FIG. 2 shows topography images acquired with constant-current control and constant-di/dz control. The image area is 48 nm×48 nm and the scan rate is 100 nm/s. Images acquired under constant-di/dz feedback exhibit improved sharpness and surface resolution.

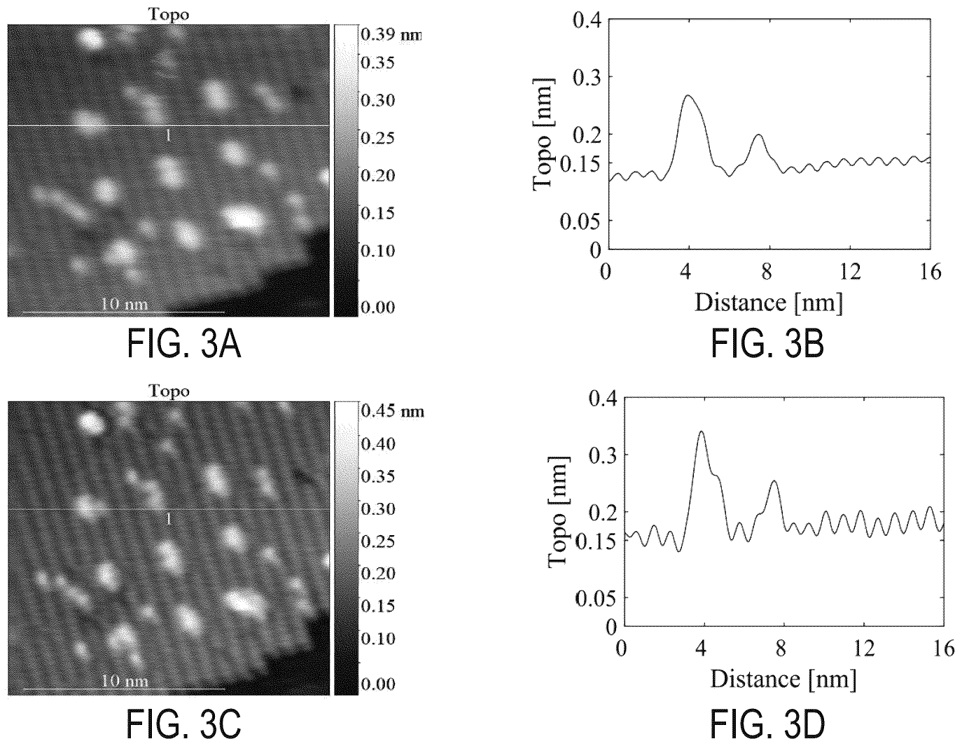

FIG. 3 shows images of a 16 nm×16 nm area in which lithography was performed using constant current control, followed by image acquisition with constant 1n(di/dz) feedback.

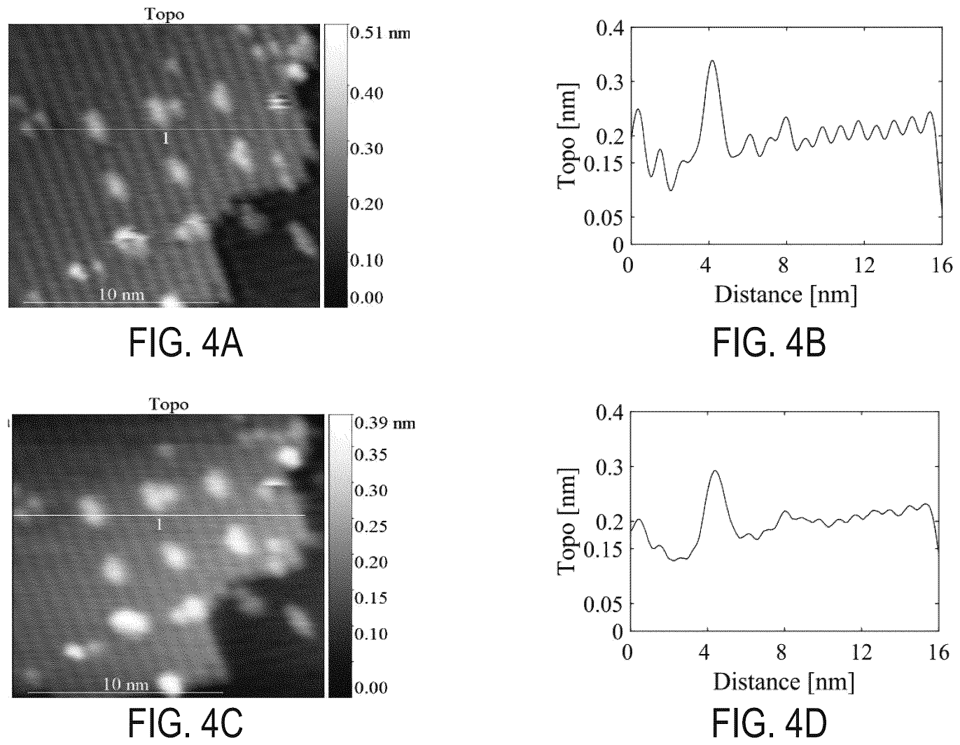

FIG. 4 shows similar operations, where lithography was performed under 1n(di/dz) feedback, followed by switching to constant current control, and then returning to 1n(di/dz). In some cases, tip instability was observed in constant-current mode but not in the 1n(di/dz) mode. These results suggest that lithography can be performed as effectively using the proposed feedback method.

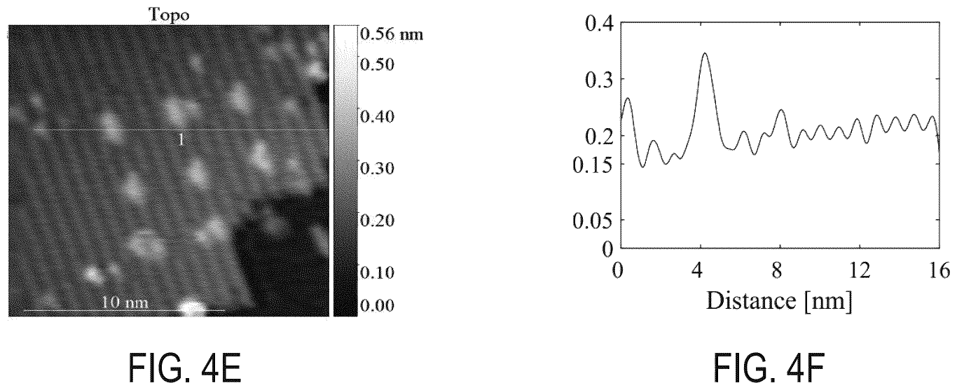

FIG. 5 shows additional results where topography images were acquired using constant di/dz feedback, and spiral lithography was performed using the same mode.

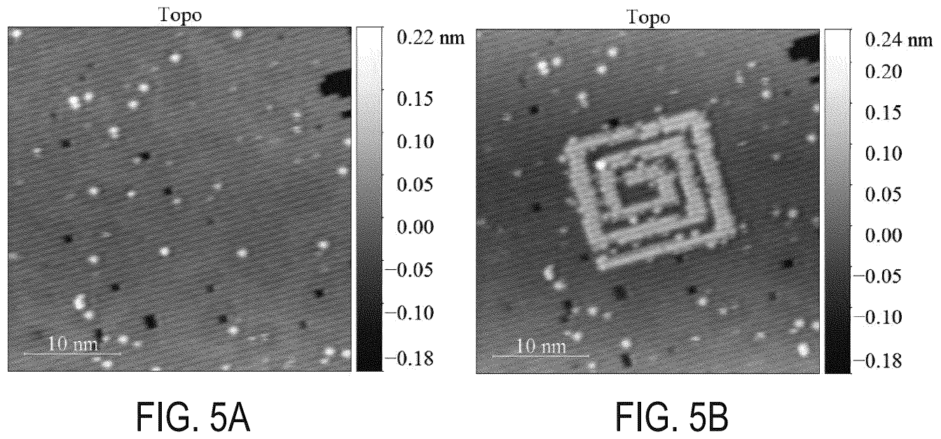

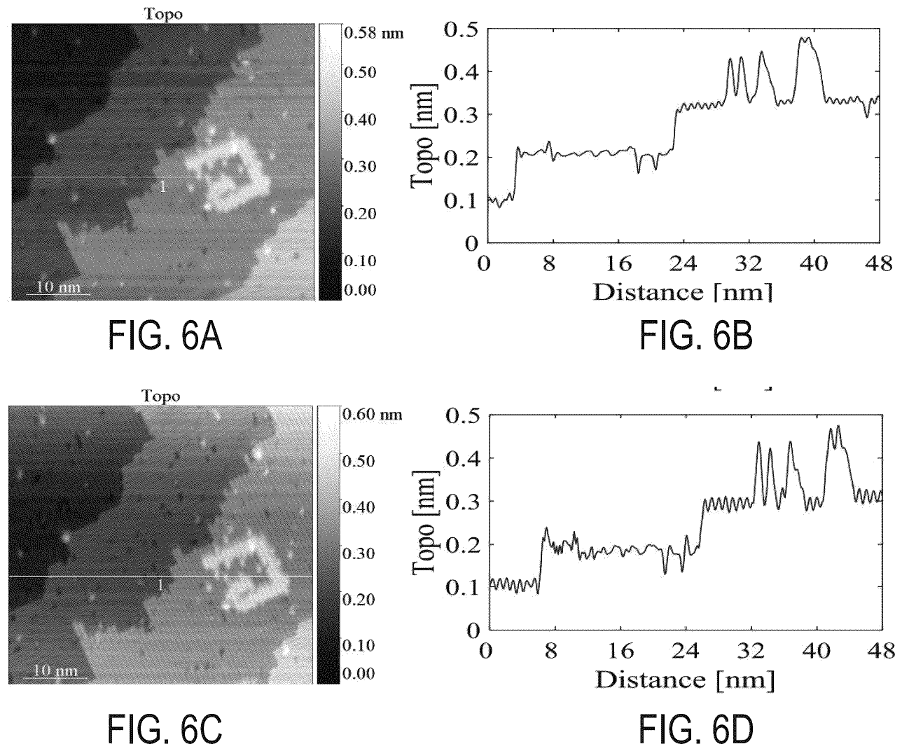

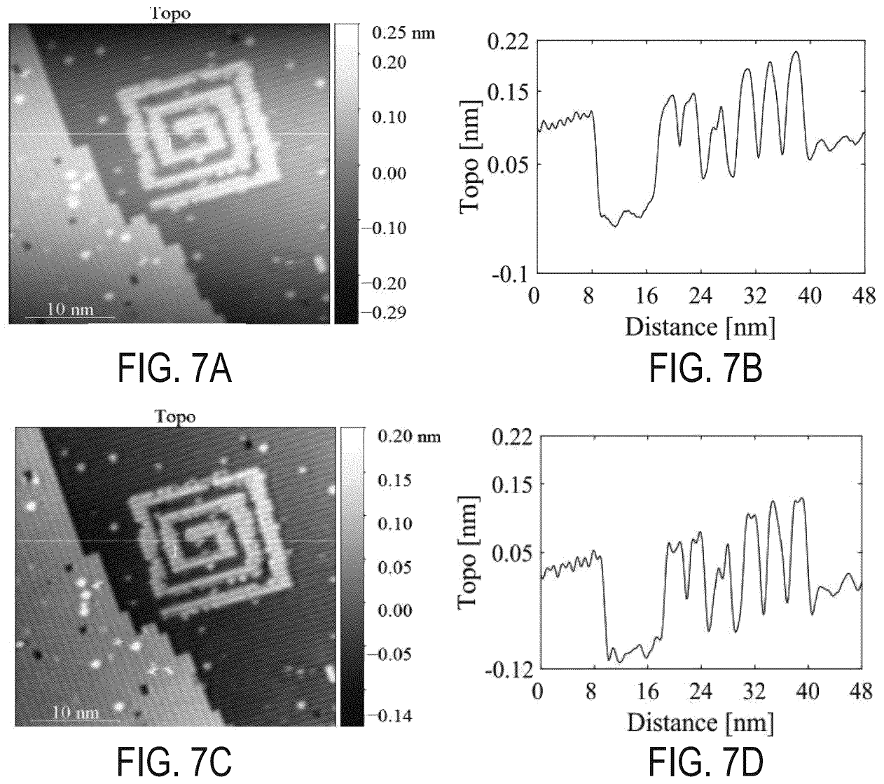

FIGS. 6-8 show comparative results that indicate improved resolution and contrast in constant-di/dz imaging, particularly in surface features with varying conductivity or LBH. To evaluate this improvement, a linearized form of Equation (2) is considered:

$$ln ( R \frac{d i}{d z} ) = ln ( - 1.025 \sqrt{φ} f ( σ , {V}_{b} ) ) - 1.025 \sqrt{φ} z \qquad ( 3 )$$

From equation (3), at least two observations can be made. First, the value of 1n(di/dz) varies linearly with z, meaning that regulating 1n(di/dz) results in regulating the tip-sample distance z, assuming other parameters remain approximately constant. Second, the term −\sqrt{φ}f(σ,V_{b})) operates as an output disturbance in the feedback loop. On a Si(100)−2×1:H surface, surface conductivity a and LBH p tend to vary inversely. Therefore, fluctuations in this disturbance are moderated, which can contribute to more stable feedback performance under 1n(di/dz) control compared to conventional 1n(i) feedback, where the disturbance is instead 1n(f(σ, Vb)), which can exhibit more abrupt spatial changes.

This feedback method may allow for improved measurement of surface variation during imaging, especially when operating in a constant di/dz mode. Maintaining this parameter during lithography can also support high-precision patterning. Accordingly, the described STM mode of operation—based on real-time feedback regulation of differential tunneling parameters—can be used to enhance imaging resolution, topography fidelity, and lithographic accuracy.

In some STM systems, the feedback loop is often configured to regulate the tunneling current i, or more specifically 1n(|i|), to control the tip-sample separation z. The relationship is approximated as Equation (1). Therefore, Equation (2).

Direct measurement of z is typically impractical. Therefore, feedback regulation is performed via an observable proxy. In some cases, di/dz can be obtained by injecting a high-frequency dither into the z-axis control signal and measuring the amplitude of the resulting high-frequency tunneling current using a lock-in amplifier.

The logarithmic form of the di/dz signal is in Equation (3). Based on this relationship, z can also be regulated using 1n(|di/dz|). Therefore, an alternative STM operating mode can involve closing the feedback loop on 1n(|di/dz|) rather than 1n(|i|).

The experimental results suggest several advantages. For example, topography images of hydrogen-passivated Si(100)−2×1:H surfaces obtained using 1n(di/dz) feedback may exhibit higher contrast relative to those obtained under conventional current-based feedback. As another example, high-precision lithography can be conducted by positioning the STM tip over hydrogen dimers and applying a tunneling current to locally break Si—H bonds. Furthermore, feedback control using 1n(di/dz) appears to exhibit greater stability in tip behavior compared to current-based feedback under similar operating conditions.

The reduced variation in output disturbance under 1n(di/dz) control may be attributed to the inverse relationship between surface conductivity and LBH, which can result in smaller net fluctuations of the disturbance term. This may enable tighter regulation of z and improved system stability during both imaging and lithographic operation.

### STM System Architecture and Experimental Operation Under Ln(Rdi/Dz) Feedback Control

A control mode for STM is described that uses feedback based on the derivative of tunneling current with respect to vertical tip displacement (di/dz). In this context, the STM system includes a conductive probe, sometimes referred to herein as the tip, that is positioned in close proximity to a sample surface to enable quantum tunneling of electrons. A high-frequency sinusoidal modulation can be superimposed on the STM control signal, and the amplitude of the resulting modulated tunneling current can be extracted to obtain a di/dz measurement as the tip is rastered across the surface. A feedback control loop can be configured to maintain the di/dz value approximately constant during scanning, which can, in some cases, enhance the sensitivity of the tip to subtle variations in surface topography and electronic structure. Such a control methodology may provide distinct advantages over conventional constant-current STM imaging techniques. These techniques have been evaluated through high-resolution imaging and hydrogen depassivation lithography experiments performed on hydrogen-terminated silicon surfaces (Si(100)−2×1:H). Validation across multiple STM platforms and under a variety of imaging conditions supports this control strategy to advance STM-based imaging, feedback control, and lithographic precision.

### INTRODUCTION

STM is often used to acquire three-dimensional real-space representations and spatially localized measurements of surface geometry and electronic characteristics of conductive materials. Due at least in part to the ability to position the tip with sub-nanometer precision, STM systems have been utilized in atomically precise manufacturing and lithography processes. In some cases, STM techniques may support fabrication of nanoscale materials and devices with high spatial resolution and geometric complexity.

The general operating principle of STM is based on electron tunneling, a quantum mechanical phenomenon that occurs when two electrically conductive surfaces are positioned within a separation distance of less than approximately 1 nanometer and are subjected to a voltage bias. Under such conditions, electrons can traverse the potential barrier between the surfaces, producing a tunneling current that is highly sensitive to the tip-sample separation. During scanning operations, regulating the vertical position of the tip to maintain a substantially constant tunneling current can allow surface features to be resolved with angstrom-scale precision.

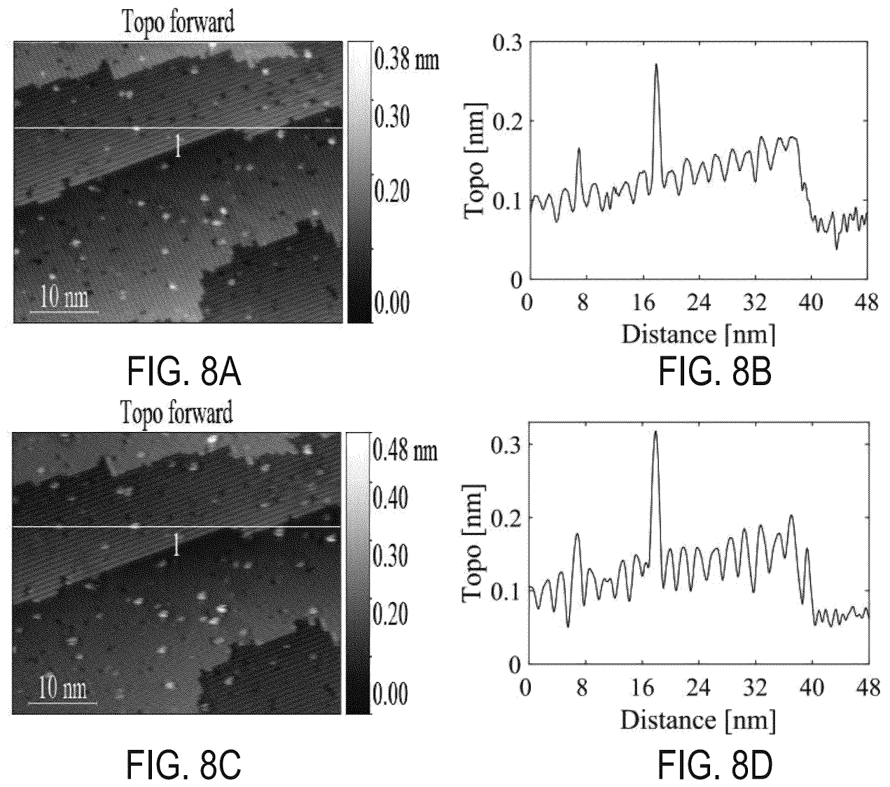

FIG. 9 illustrates an example STM system operating in a CCM. The system includes a piezoelectric tube scanner configured to position a conductive tip over a sample surface along a defined scanning path within an ultra-high vacuum (UHV) environment. A bias voltage (V_{b}) is applied between the tip and the sample, resulting in a tunneling current (i), which is provided to a preamplifier configured to amplify the measured current. The amplified signal is supplied to a PI controller that adjusts the vertical (z-axis) position of the tip by generating drive signals for the piezoelectric scanner. The PI controller operates to maintain a substantially constant tunneling current during scanning. The resulting tip displacement signal may be used to generate a topography output, which can undergo post-processing and be rendered for image display. By maintaining the tunneling current approximately constant as the tip raster-scans the surface, the system can be configured to resolve surface variations with angstrom-scale resolution.

Piezoelectric actuators integrated into an STM system can be configured to provide precise three-dimensional positioning of the tip and to enable controlled scanning over the sample surface. However, achieving sub-nanometer spatial resolution can be limited by nonlinearities in the actuator response and by the presence of electrical and mechanical noise. Furthermore, the resonant frequency of the piezoelectric tube scanner can impose limits on achievable scan rates, affect mechanical stability under vibration, and constrain noise reduction strategies in the associated electronics. These limitations may result in reduced image quality or degraded topographic resolution. Despite the importance of STM control system design, relatively few improvements have been implemented since the initial development of STM technology.

Various prior efforts have analyzed STM control systems to determine optimal imaging conditions and to identify suitable feedback parameters. Some approaches have included the design of robust controllers tailored to specific STM platforms. In addition, PI control structures have been proposed to prevent tip-sample collisions, thereby contributing to a better understanding of STM system dynamics and associated design challenges.

Research continues to explore ways to improve STM performance by analyzing tradeoffs between imaging stability, scan speed, control robustness, and resolution of subtle surface variations. Although alternative control strategies have demonstrated improvements in certain STM imaging metrics, commercial STM systems often continue to rely on PI-based control loops due to their relative simplicity and ease of implementation. Nonetheless, further innovation in feedback control design remains important to fully realize the performance capabilities of STM and to enhance interpretation of high-resolution topography data.

Prior investigations have addressed stability issues in closed-loop STM systems operating under fixed-gain PI control. It has been demonstrated that variations in the local barrier height (LBH) can result in system instabilities when static PI gains are applied. To address this limitation, self-tuning PI controller architectures have been proposed that dynamically adjust PI gains based on LBH measurements, thereby mitigating feedback instability.

In additional prior work, feedback control schemes that utilize the natural logarithm of the differential conductance, 1n(Rdi/dV), in place of tunneling current have been implemented. These alternative control strategies can regulate the tip-sample spacing even under conditions of zero DC sample bias voltage. In some cases, such configurations enable faster acquisition of current-voltage (I-V) curves, thereby improving the speed and efficiency of spectroscopic measurements relative to conventional STM spectroscopy techniques. Kalman filter-based estimation frameworks have also been described in combination with PI control structures, allowing for simultaneous estimation of surface conductivity and topography.

Some aspects of the present disclosure introduce a feedback control mechanism for STM imaging and lithography that is configured to dynamically regulate the vertical tip position during raster scanning while superimposing a high-frequency modulation on the controller output. The feedback loop can be closed based on a logarithmic signal derived from the di/dz measurement, specifically 1n(Rdi/dz), where R is the transimpedance gain. This approach improves image quality and supports high-precision topography acquisition.

Some advantages of the disclosed control scheme include its ability to accurately measure fine surface variations. By maintaining the 1n(Rdi/dz) signal approximately constant during scanning and leveraging the dynamics of the feedback loop, the system can increase sensitivity to minor changes in surface topography. The controller output, while the loop is closed on 1n(Rdi/dz), reflects surface features and may be processed to generate detailed images of sample topography and structure. This imaging capability supports precise nanoscale surface analysis using STM.

### II. STM and Modulation Techniques

This section provides an overview of the tunneling phenomenon utilized in STM and reviews conventional modulation techniques employed to characterize surface properties. A feedback control approach based on a substantially constant di/dz measurement is also introduced and is configured to improve topography image resolution under certain operating conditions.

### A. The Tunneling Phenomenon

STM systems are configured to acquire images by scanning a conductive tip laterally across a conductive sample surface while regulating the vertical position of the tip based on tunneling current feedback. In a typical configuration, a tungsten (W) probe having a sharp conductive tip is positioned in close proximity to the sample. When the tip and the sample approach each other within a distance of approximately 0.5 to 5 nanometers, their quantum wave functions begin to overlap, and electrons can tunnel across the potential barrier in response to an applied bias voltage (V_{b}) between the sample and the tip. This tunneling behavior results in a measurable tunneling current (i), which can be modeled as:

$$i = f ( σ , {V}_{b} ) {e}^{- 1.025 \sqrt{φ} δ} \qquad ( 4 )$$

where δ=zₜ−h (in nm) is the sample-tip separation, zₜ is the tip displacement due to controller output, u, and h is the surface topography. Also, φ (in eV or nA/nm) is the average work function of the tip and sample, known as the LBH, and σ (in nA/V) represents the electron density of the sample. The parameters 6 and <p are surface-dependent and characterize both the physical and electronic properties of the sample. Although Equation (4) represents a simplified tunneling current model, it effectively captures the fundamental operational behavior of STM. The tunneling current exhibits an exponential dependence on tip-sample spacing: for example, a reduction of approximately 0.1 nm in tip-sample distance may increase the current by a factor of 100. This sensitivity allows for precise regulation of vertical tip position and can support atomic-scale vertical resolution. However, high-resolution imaging generally requires favorable conditions, such as sharp tips and minimal tip-sample separation; otherwise, image clarity may be reduced due to blurring or spatial averaging effects.

In a constant current imaging mode, a feedback control system regulates the tip height to maintain a substantially constant tunneling current. A fixed bias voltage is applied to the sample while the tip is grounded. As the tip moves laterally over the surface, the tunneling current changes in response to variations in sample height and electronic structure. A feedback loop modulates the tip position to counteract these changes and preserve a target tunneling current level. The vertical control signal generated by the system can be used to construct a topographic image of the surface.

To support linear feedback control design, the tunneling current expression in Equation (4) may be linearized by taking its natural logarithm. This produces a linear relationship between the logarithmic tunneling current and tip-sample spacing:

$$ln ( Ri ) = ln ( R f ( σ , {V}_{b} ) ) - 1.025 \sqrt{φ} δ \qquad ( 5 )$$

Here, R denotes the gain of the transimpedance amplifier (in volts per nanoampere) used to convert the tunneling current into a measurable voltage signal. The resulting control signal corresponding to the tip's vertical adjustment represents a map of the surface's constant charge density contour and serves as the topography image.

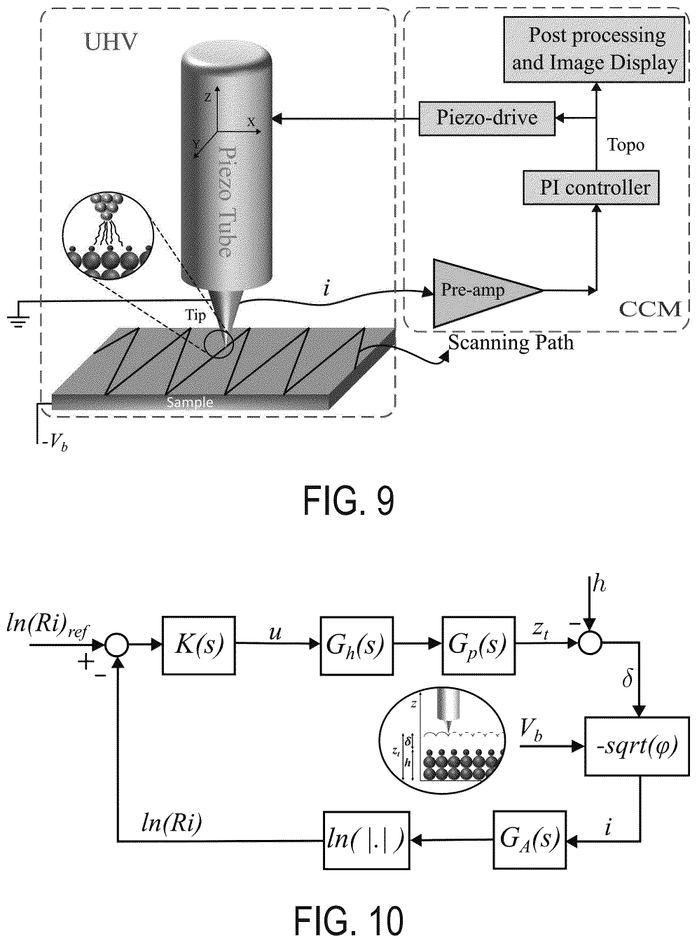

FIG. 10 illustrates an example block diagram for a CCM STM feedback control system. The system includes a proportional-integral controller K(s), which receives an error signal corresponding to the difference between a reference value 1n(Ri)_{ref} and the measured signal 1n(Ri). The controller generates a control signal u, which is amplified by a high-voltage amplifier Gₕ(s) and applied to a piezoelectric actuator Gₚ(s) to adjust the vertical position zₜ of the STM tip. The difference between the adjusted tip position (zₜ) and the sample topography (h) defines the tip-sample spacing 6. The tunneling current i, resulting from the applied bias voltage V_{b}, is measured and amplified by a preamplifier G_{A}(s), then passed through a logarithmic amplifier to generate 1n(Ri) for use in the feedback loop. This control architecture is configured to maintain a substantially constant tunneling current throughout scanning and enables the generation of high-resolution topographic images.

In addition to geometric surface profiling, constant current topography may also reflect local variations in electronic structure. However, distinguishing between geometric and electronic contributions to the topography signal can be difficult. Accordingly, modulation techniques are often applied to extract additional spectroscopic information.

### B. Example Lock-In Amplifier

Estimation of surface-dependent parameters in STM often involves the use of a LIA. Various STM spectroscopy techniques can incorporate LIA components due to their effective demodulation capabilities and frequency selectivity. In some cases, the narrow tracking bandwidth of an LIA may substantially reduce sensitivity to undesired frequency components and improve the ability to isolate and recover weak signals in noisy environments. A lock-in amplifier can be configured to extract amplitude and, in some cases, phase information from a particular frequency component of an input signal.

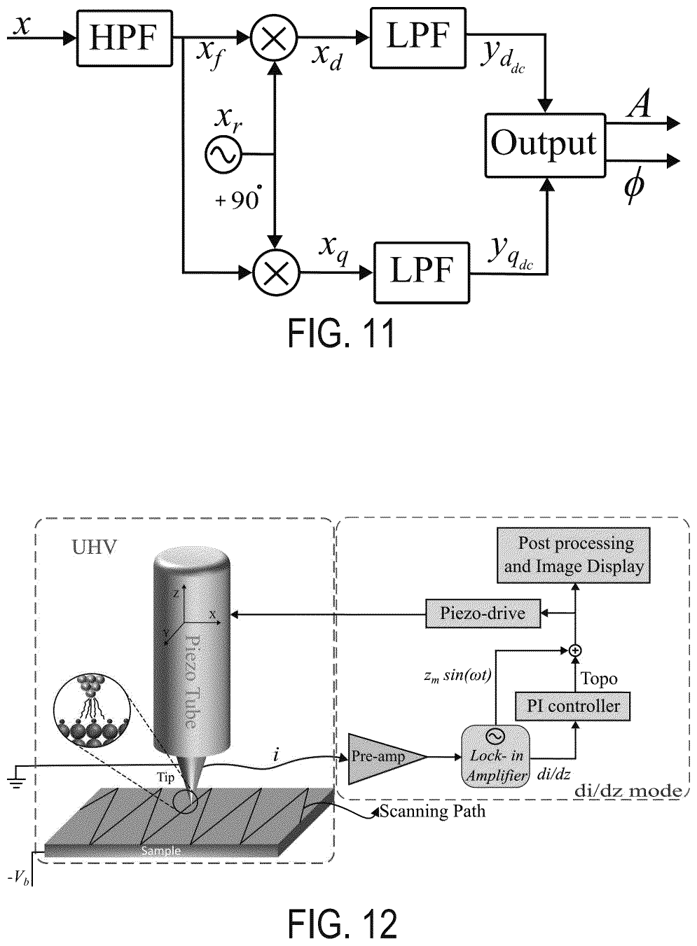

FIG. 11 illustrates an example block diagram of a LIA system that can be used to extract amplitude and phase information from an input signal. As shown, an incoming signal may first be processed by a high-pass filter (HPF), followed by multiplication with a reference signal (xᵣ) and a quadrature signal (x_{q}), which is phase-shifted by approximately +90 degrees. The resulting components (x_{d} and x_{q}) can then be passed through low-pass filters (LPFs) to produce signals y_{qdc} and y_{ddc}, respectively. These signals may be used to calculate the amplitude (A) and phase (phi) of the original input signal. For clarity, time dependencies are omitted in this diagram.

Based at least in part on these principles, scanning tunneling spectroscopy (STS) is frequently used as a modulation technique for extracting electronic surface parameters. In some approaches, the sample bias voltage bias voltage, V_{b}, is modulated and tunneling current, i is obtained as f(V_{b}+Vₘ sin(ωt)). This tunneling current, when passed through LIA, tuned at ωᵣ=ω, gives

$$\frac{\partial ln i}{\partial ln V} \approx σ \qquad ( 6 )$$

In some cases, when the modulation voltage amplitude is relatively small, the first derivative of the tunneling current with respect to bias voltage may approximate the local density of states (LDOS) or surface conductivity (σ) of the sample.

An additional STM spectroscopy method, referred to as the gap modulation method, may be used to estimate the LBH. In this method, a modulation signal at frequency ωᵣ=ω can be applied to the controller output u, inducing small vertical oscillations of the STM tip relative to the surface. The amplitude of the signal 1n(Ri), tracked at frequency ω using a lock-in amplifier, may provide an estimate of the work function ω:

$${( \frac{\partial ln i}{\partial z} )}^{2} \approx φ \qquad ( 7 )$$

The surface parameters obtained from Equations (6) and (7) can be influenced by both the sample and tip electronic properties. These measurements can be referred to as LDOS and LBH, respectively, and may be used to generate spatially resolved maps of surface conductivity and local barrier height. Such maps can offer additional insights into surface physics, beyond the geometric information available through topographic imaging alone.

C. Example Feedback Control Loop Based on 1n(Rdi/dz)

A STM feedback control method is described herein that used feedback based on the differential conductance di/dV, building upon prior implementations involving feedback control of tunneling current and related measurements. Prior implementations demonstrated benefits of using di/dV feedback to obtain a symmetric I-V curve for the sample surface, among other advantages.

In some cases, the feedback loop may alternatively be closed on the natural logarithm of the differential tunneling current without explicit transimpedance scaling. That is, the control loop may operate using a signal proportional to 1n(di/dz) rather than 1n(R·di/dz). This configuration may be useful, for example, in settings where the transimpedance gain R is constant and incorporated into the downstream controller calibration. The techniques described herein are intended to encompass both forms of the feedback metric, which may be interchangeable depending on implementation details and signal processing configurations.

Based on this principle, a feedback control mechanism can be configured specifically for imaging and lithography applications, including those utilizing multiple STM tips in high-throughput lithography environments. Insights from previously implemented control methods can be leveraged to inform performance characteristics of the present feedback loop. This control strategy can redefine STM feedback architectures and enable broader applicability in complex nanoscale imaging and fabrication contexts.

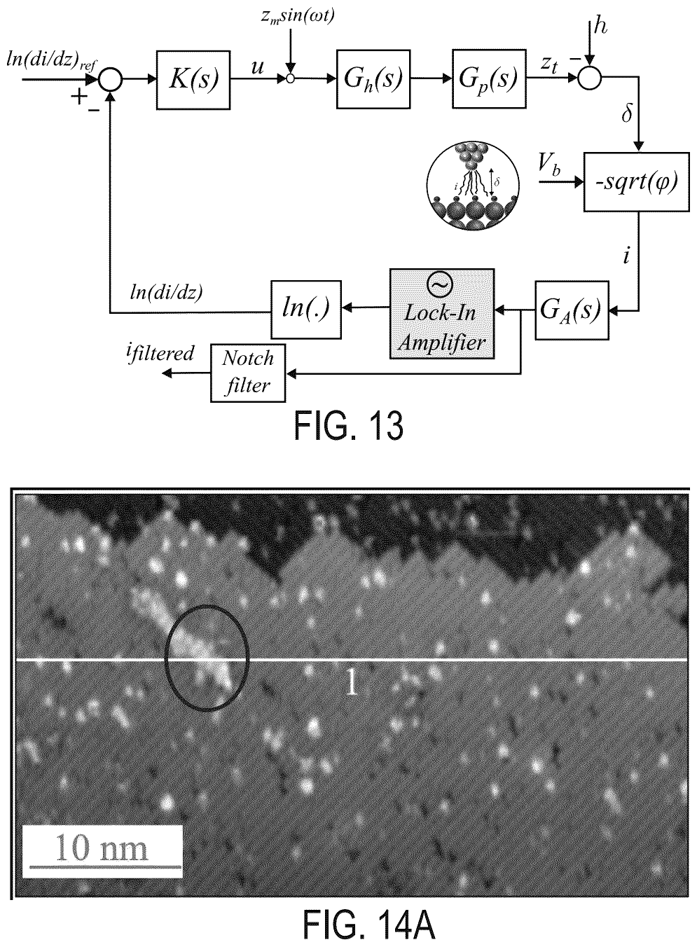

FIG. 12 illustrates an example block diagram of a STM operating in a constant di/dz feedback mode. A sinusoidal modulation signal, expressed as zₘ sin(ωt), can be superimposed onto the controller output. The resulting tunneling current can be processed by a preamplifier and a lock-in amplifier to extract the di/dz signal. A PI controller can regulate the di/dz value to maintain a constant feedback condition. The resulting controller output can be used to adjust the piezoelectric actuator, thereby controlling the tip-sample separation along a defined scanning path. The system can operate under UHV conditions and can further support image post-processing and display based at least in part on the tip position and the maintained feedback signal.

In such configurations, tip-sample distance can be controlled by a feedback controller that regulates di/dz. The system is configured to maintain 1n(Rdi/dz) at a constant value throughout a scan.

From Eq. 1, we may write

$$\frac{d i}{d z} = - 1.025 \sqrt{φ} f ( σ , {V}_{b} ) {e}^{- 1.025 \sqrt{φ} δ} \qquad ( 8 )$$

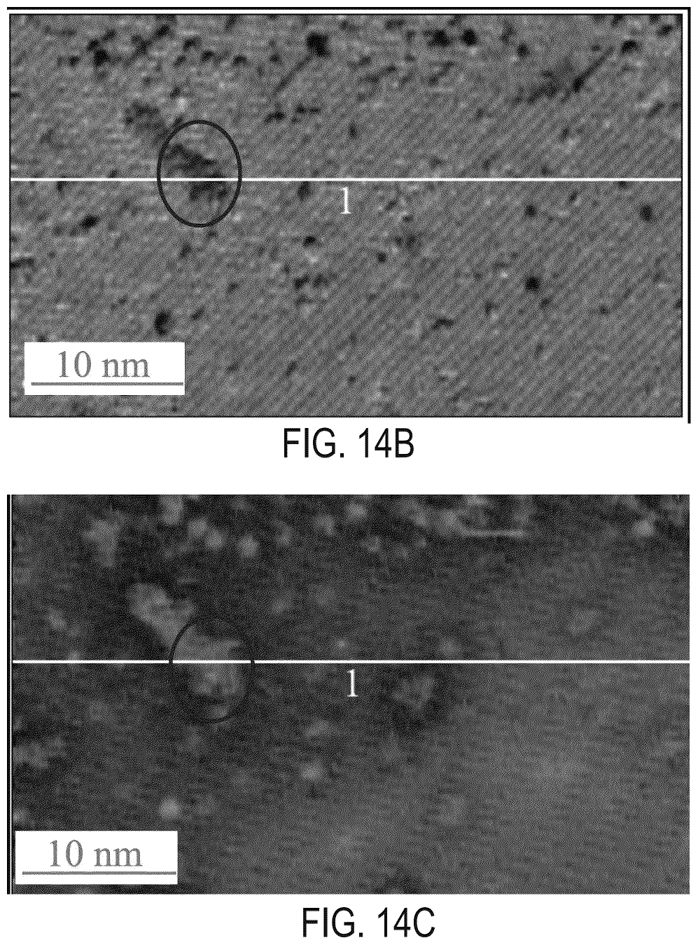

FIG. 13 illustrates an example control block diagram of the z-axis of a STM operating in a constant di/dz feedback mode. A modulation signal (e.g., a high-frequency sinusoidal modulation signal), expressed as zₘ sin(cot), can be superimposed on the controller output signal u. This signal can be amplified by a high-voltage amplifier, denoted as Gh(s), and then used to drive a piezoelectric actuator represented as Gp(s). The resulting tip displacement zt, together with the sample surface topography h, can define the tip-sample separation δ. A preamplifier, denoted as GA(s), can convert the tunneling current into a measurable voltage signal. This signal can be passed through a lock-in amplifier to extract the di/dz value. After applying filtering, the extracted signal can be converted to its natural logarithm form and compared to a reference value of 1n(Rdi/dz). A PI controller, denoted as K(s), can then regulate the tip-sample separation based on the resulting error signal, thereby enabling accurate and stable surface tracking during raster scan operations.

Based on Eq. 1, the feedback architecture can include a modulation technique that allows simultaneous acquisition of the di/dz signal along with the topography image. A sinusoidal modulation signal, zₘ sin(cot), can be superimposed on the controller output u, and the amplitude of the AC component of the tunneling current at the modulation frequency can be measured using a LIA. During scanning, the feedback loop maintains the tunneling current amplitude at the modulation frequency at a constant level.

FIG. 13 further illustrates the associated control block diagram for a UHV STM operating in this configuration. The feedback loop is closed on the 1n(Rdi/dz) signal. The error signal is defined as the difference between the set-point and the natural logarithm of the measured di/dz signal. A proportional-integral controller is configured to regulate the di/dz signal, and in turn the tip-sample distance, to minimize the error. The controller output, along with the X and Y position of the tip, can be used to construct a topographic image of the sample surface.

To understand the functional basis of the feedback control loop, Eq. 5 is linearized:

$$ln ( R \frac{d i}{d z} ) = ln ( - 1.025 \sqrt{φ} f ( σ , {V}_{b} ) ) - 1.025 \sqrt{φ} 6 \qquad ( 9 )$$

At least two observations can be drawn from Eq. 6. First, 1n(Rdi/dz) exhibits a linear dependence on δ, the tip-sample gap. As a result, by regulating 1n(Rdi/dz), the system can effectively regulate δ, assuming all other parameters remain constant. Second, all surface characteristics and disturbances are reflected in the controller output signal, which can encode relevant disturbance information. In such STM feedback control systems, two types of disturbances can be distinguished: (1) input disturbances due to surface topography variations, represented by h, and (2) output disturbances associated with electronic properties of the surface, represented by 1n(f(σ, V_{b})) in conventional constant-current feedback implementations.

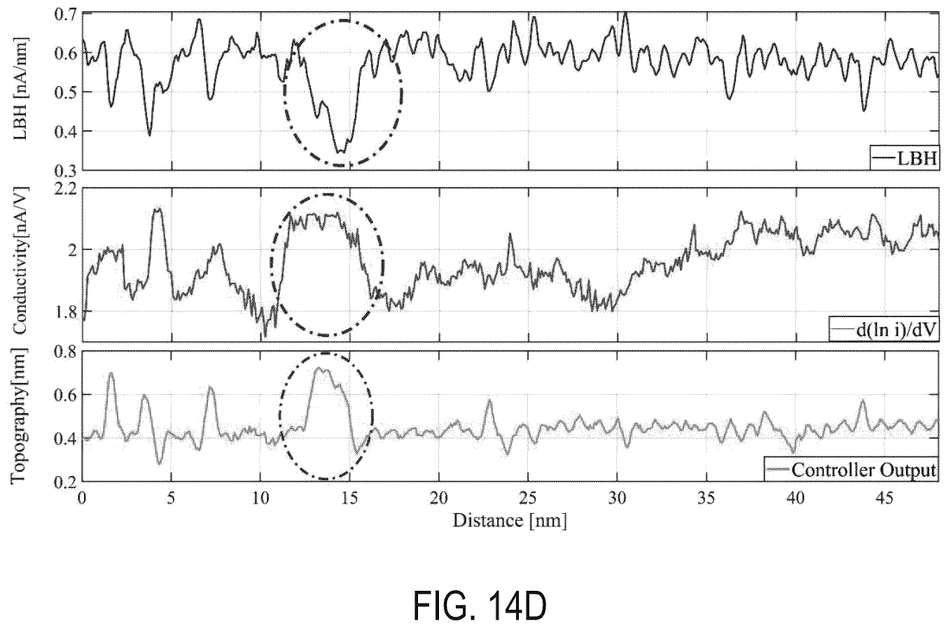

In the case of a feedback loop closed on 1n(Rdi/dz), the term 1n((−1.0259√φf(σ,V_{b}))) functions as an output disturbance. As shown in FIGS. 14A-14D, which depicts imaging data from a Si(100) 2×1:H surface, LBH values are reduced in regions of higher surface conductivity a, and increased where a is lower. Consequently, surface conductivity and LBH exhibit inverse behavior on the Si(100) 2×1:H surface.

These electronic disturbances may vary in their effect depending on the feedback strategy. For both feedback configurations—conventional current feedback and di/dz feedback—the input disturbance h remains constant. However, the electronic output disturbance affects each control loop differently. In constant-current control, the electronic output disturbance may vary substantially across the surface, reducing control performance. In contrast, the feedback loop closed on 1n(Rdi/dz) exhibits moderated response to such disturbances, enabling more consistent control performance as the tip scans across regions of varying conductivity. Accordingly, higher-resolution imaging can often be achieved at greater tip-sample distances using di/dz feedback, while conventional constant-current feedback may require the tip to be positioned closer to the surface. The same consideration can apply in high-resolution hydrogen depassivation lithography (HDL) operations.

FIGS. 14A-14D illustrate topography, LBH, and conductivity maps of a Si(100)-2×1:H surface acquired using constant-current STM feedback, with profile comparisons highlighting the influence of dangling bonds on tunneling parameters and system response. FIG. 14A illustrates a topography image. FIG. 14B illustrates a local barrier height (LBH) image. FIG. 14C illustrates a conductivity image derived from a values obtained using modulation-based measurements. FIG. 14D illustrates a plot comparing LBH, conductivity, and controller output values extracted along the profile line labeled “1” in FIGS. 14A-14C. As shown, regions with dangling bonds exhibit reduced LBH and increased conductivity, resulting in elevated controller output. The observed LBH reduction corresponds to the first term in Equation (6), leading to a doubling of effective system gain and enabling improved disturbance rejection in the 1n(Rdi/dz) feedback loop.

D. Model Discovery for 1n(Rdi/dz) Feedback Loop

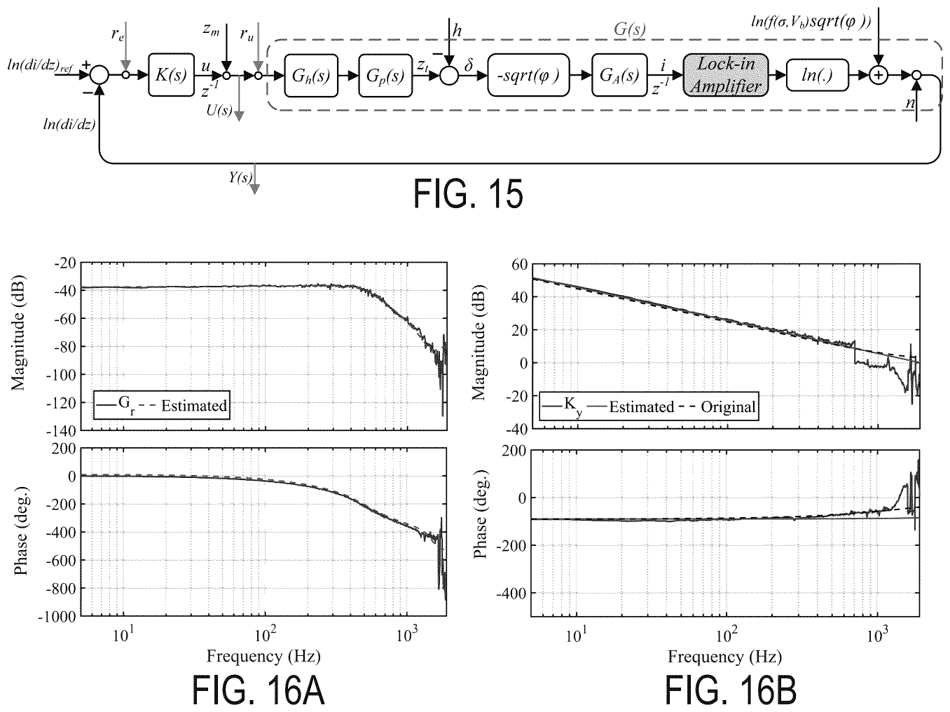

FIG. 15 illustrates an example control block diagram configured for model discovery of an STM system operating under 1n(Rdi/dz) feedback. The block diagram includes locations for injecting exogenous signals re and ru at the reference input and controller output, respectively. These signals facilitate frequency-domain identification by enabling measurement of the system's response at the controller output U(s) and plant output Y(s), corresponding to 1n(di/dz). The red dashed box indicates the portion of the system modeled as the open-loop transfer function G(s), encompassing actuator dynamics, tunneling current generation, and lock-in amplifier demodulation. This configuration supports derivation of multiple transfer functions for accurate system identification while maintaining closed-loop operation.

Designing a controller for the 1n(Rdi/dz) feedback loop often involves developing a mathematical model of the open-loop system, denoted as G(s). Frequency-domain system identification procedures can be applied to obtain this model. These procedures may be conducted using the linearized STM system configuration shown in FIG. 15 and are performed with the feedback loop enabled and tunneling current established.

The methodology may involve introducing exogenous signals re and ru at the set-point input and controller output u, respectively, while simultaneously recording the corresponding plant input U(s) and output Y(s). These signals represent the controller output u and the STM measurement 1n(Rdi/dz). The frequencies of the exogenous signals can be swept over a range such as 5 Hz to 1500 Hz. At each frequency point, output signals may be averaged across multiple measurements to reduce the effect of noise. Each exogenous signal is applied independently, and the procedure can be repeated to characterize both plant and controller dynamics.

Based on this experimental setup, the following transfer functions may be derived:

$${G}_{reU} ( s ) = \frac{K ( s )}{1 + G ( s ) K ( s )} \qquad ( 10 )$$

$${G}_{r e Y} ( s ) = \frac{G ( s ) K ( s )}{1 + G ( s ) K ( s )} \qquad ( 11 )$$

$${G}_{ruU} ( s ) = \frac{- G ( s ) K ( s )}{1 + G ( s ) K ( s )} \qquad ( 12 )$$

$${G}_{ruY} ( s ) = \frac{G ( s )}{1 + G ( s ) K ( s )} \qquad ( 13 )$$

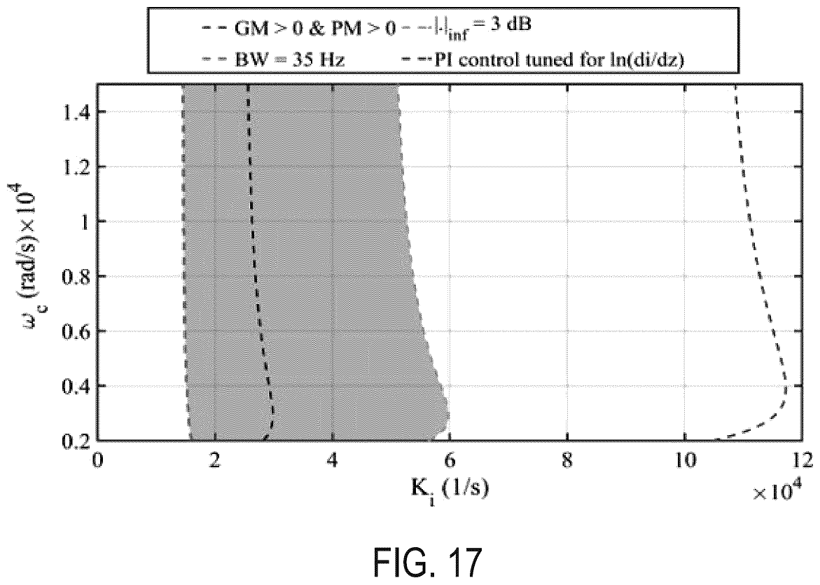

FIGS. 16A and 16B illustrate example frequency response plots used to evaluate the STM system model derived from the configuration shown in FIG. 15. FIG. 16A presents the measured and fitted magnitude and phase responses of the plant transfer function G(jω), while FIG. 16B presents the corresponding plots for the controller transfer function K(jω). The solid blue lines represent recorded frequency response data across a logarithmic frequency sweep, and the red dashed lines indicate fitted model curves based on a seventh-order transfer function. The close agreement between measured and estimated responses supports the validity of the identified models used for controller design.

The STM plant transfer function G(jω) can be computed from these frequency response functions as:

$$G ( j ω ) = {G}_{r} ( j ω ) = \frac{{G}_{{r}_{e} Y} ( j ω )}{{G}_{{r}_{e} U} ( j ω )} \qquad ( 14 )$$

The frequency response of the controller K(jω) can likewise be determined from:

$$K ( j ω ) = {K}_{y} ( j ω ) = \frac{{G}_{{r}_{e} Y} ( j ω )}{{G}_{{r}_{u} Y} ( j ω )} \qquad ( 15 )$$

A seventh-order model is often fitted to the measured G(jω) data, as illustrated in FIG. 16A. A model of the controller frequency response may be extracted in a similar manner, as shown in FIG. 16B.

Scanning tunneling microscope systems commonly employ a PI controller to regulate the tip-sample spacing. The PI controller may be represented as:

$$K ( s ) = {k}_{i} ( \frac{1}{s} + \frac{1}{{ω}_{c}} ) \qquad ( 16 )$$

where kᵢ is the integrator gain and ω_{c}, is the corner frequency. The selection of these parameters influences the overall performance and stability of the closed-loop system. Once a model for G(s) is available, analytical techniques may be used to guide PI controller tuning.

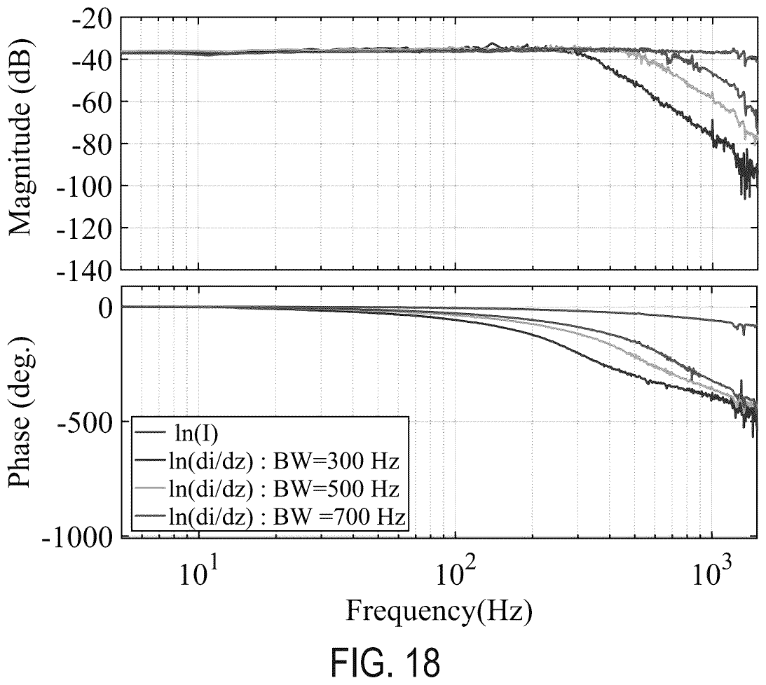

FIG. 17 illustrates an example design space for selecting PI controller parameters kᵢ and ω_{c} for use in the 1n(Rdi/dz) feedback loop. The shaded region denotes the allowable parameter combinations that satisfy constraints on stability margins, minimum imaging bandwidth, and gain bounds. Specifically, the red dashed boundary corresponds to a minimum bandwidth of approximately 35 Hz, the green boundary indicates a maximum closed-loop gain of 3 dB, and the blue boundary enforces gain and phase margin conditions. A black dashed line marks a representative PI tuning configuration used in practice. This visualization aids in identifying feasible and stable PI parameter sets for STM operation under di/dz feedback.

Selection of PI parameters can be based on three design criteria: (i) an upper bound on kᵢ defined by gain margin limits, (ii) a lower bound defined by a minimum imaging bandwidth (e.g., approximately 35 Hz), and (iii) a constraint on the maximum allowable gain of the closed-loop system, typically set to remain below 3 dB. These criteria are graphically represented in FIG. 17. The allowable range of integrator gains kᵢ for a given corner frequency ωc is shown by the shaded region. A dashed black line in FIG. 17 indicates a recommended operating point, set at approximately one-half of the maximum permitted gain.

Tuning the controller can begin by selecting a suitable oc. A value such as ω_{c}=10⁴ rad/sec may be selected to reduce nonlinear effects while remaining below the first mechanical resonance of the system. A low-pass filter within the feedback loop may help attenuate high-frequency noise and suppress the amplitude of resonant peaks. This configuration supports placement of the cutoff frequency near the first resonance without degrading system stability. The integrator gain kᵢ may then be increased incrementally until oscillations appear in the current signal. The operational value of kᵢ can be selected at approximately half the value at which such oscillation occurs.

The bandwidth of the open-loop system G(s) is influenced in large part by the low-pass characteristics of the LIA, particularly the settings of its low-pass filter (LPF).

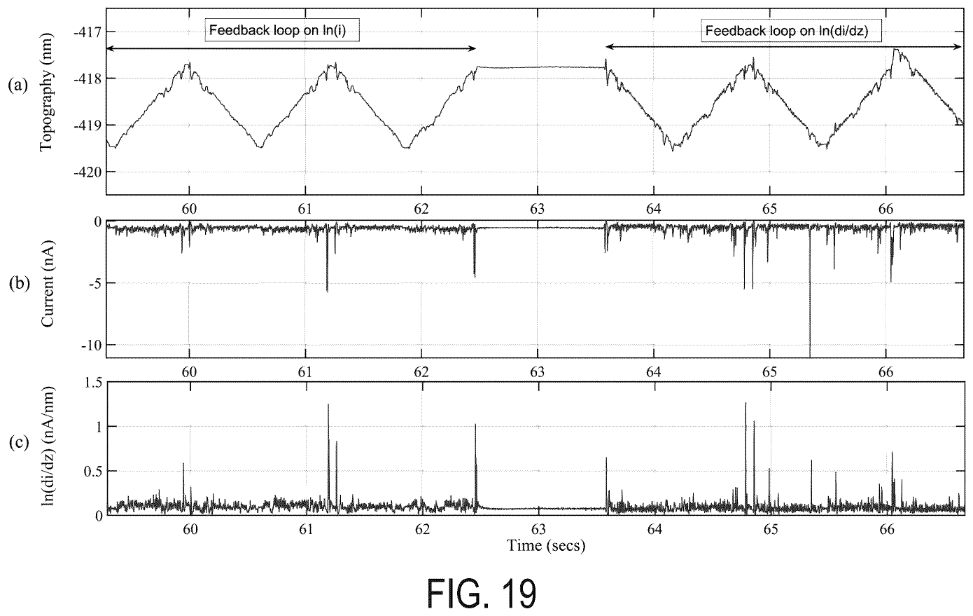

FIG. 18 presents measured open-loop frequency responses for three different LPF cutoff frequencies. In general, the bandwidth increases with higher LPF settings. The LPF can be used to suppress out-of-band disturbances and improve the signal-to-noise ratio (SNR) of the extracted signal. However, narrower LPF settings, while improving SNR, may constrain the system to lower scanning speeds. This tradeoff can be advantageous in rejecting high-frequency disturbances that might otherwise excite resonant modes or increase the risk of tip damage during scanning.

FIG. 18 shows open-loop frequency responses of the STM system operating in constant 1n(Rdi/dz) feedback mode. A modulation voltage at 2 kHz with an amplitude of 0.8 mV was superimposed on the controller output u. The resulting current was demodulated at the fundamental frequency, and the feedback loop was engaged to maintain a set-point value of 0.5 nA/nm. Responses were recorded using LPF cutoff frequencies of 300 Hz, 500 Hz, and 700 Hz. For comparison, the system response under constant-current imaging mode is also included.

### III. Example Results

This section presents example validation of the STM feedback loop described above. Imaging and lithography were conducted under conventional and di/dz-based feedback conditions to compare performance. Hardware configurations, sample preparation, and signal processing details are included.

### A. Experimental Setup

Experiments were performed using two STM platforms: a home-built Lyding scanner-based STM system and a ScientaOmicron Variable Temperature Scanning Probe Microscope (VT SPM). Both platforms were maintained at room temperature within a UHV environment at pressures on the order of 10⁻¹¹ Torr.

The imaging sample was an approximately 4 mm×10 mm hydrogen-passivated Si(100)−2×1 surface prepared under UHV conditions. Preparation steps included degassing at approximately 650° C. for 8 to 10 hours, followed by five flash cycles to approximately 2040° C. for 30 seconds each. After cooling to approximately 300° C., the sample was exposed to a background pressure of atomic hydrogen at 10⁻⁶ Torr for 10 minutes, forming a monolayer of hydrogen atoms on the surface. The atomic hydrogen was generated by cracking background H₂ gas using a tungsten filament operated at approximately 1300° C.

Current measurements for the home-built STM system were performed using a Femto DLPCA-200 current preamplifier with a gain of 1 V/nA and bandwidth of approximately 1.1 kHz. For the ScientaOmicron VT SPM, current measurements used a preamplifier configured with a 330 nA range, approximately 0.03 V/nA gain, and selectable bandwidths of 3 kHz or 100 kHz. These measurements were conducted under an unfiltered current setting. Both STM systems were controlled using a 20-bit digital signal processing (DSP) unit operating at approximately 100 kHz sampling rate. This DSP unit included digital-to-analog (D/A) and analog-to-digital (A/D) channels, each with 20-bit resolution and ±10 V range.

Actuation of the piezotube was achieved using a high-bandwidth, low-noise high-voltage amplifier with a gain factor of approximately 13.5. The DSP software and control environment were provided by Scanz™ and Zyvector™, which integrate the STM feedback control mechanisms. System parameters, including feedback loop configuration, were adjustable using Python scripting via Scanz™. All STM imaging results referenced herein were generated using the described instrumentation and control architecture.

### B. Example Constant Di/Dz Feedback Loop

Initial approach of the STM tip to the sample was performed using a slip/stick coarse-positioning mechanism. The tip was advanced toward the sample in automated, high-sensitivity increments until the sample surface entered the operational range of the fine positioning system. During this process, the piezoelectric scanner extended to its maximum range, and the coarse positioner decreased the tip-sample gap. Continuous monitoring of the tunneling current was used to detect tip-sample interaction. Upon detecting tunneling current, the scanner retracted. This sequence was repeated until the tip was correctly positioned within the operational range of the fine scanner. A constant tunneling current was established and maintained at a predetermined set-point using a feedback loop configured to regulate 1n(Ri).

After stabilizing the tip, the system was transitioned to a constant di/dz feedback mode by superimposing a sinusoidal modulation signal onto the controller output signal u. The modulation signal was defined with an amplitude zₘ of approximately 0.8 mV and a frequency ω of approximately 2 kHz. The amplitude was selected to maintain tip oscillations within approximately 0.1 nm, and the modulation frequency was chosen to remain outside the closed-loop bandwidth to reduce the likelihood of exciting mechanical resonances. These parameters were applied uniformly across all experimental procedures.

The sinusoidal modulation introduced high-frequency components into the tunneling current, generating harmonics of the modulation frequency. To isolate the relevant frequency component, five notch filters were applied to suppress the fundamental and higher-order harmonics. The filtered tunneling current signal was then passed through a LIA, and the resulting output was processed to obtain the natural logarithm of di/dz. This signal, 1n(Rdi/dz), served as the input for a feedback control loop configured to regulate the vertical tip position.

Referring back to FIG. 5, FIG. 5 illustrates an example control block diagram for the constant 1n(Rdi/dz) feedback loop. The controller output u is modulated with zₘ sin(ωt) and amplified via Gh(s), then applied to the piezoelectric actuator Gₚ(s) to adjust tip displacement zₜ. The tip-sample separation δ is defined as the difference between zₜ and the sample surface topography h. The resulting tunneling current i is processed by a preamplifier GA(s), then filtered and demodulated by the LIA to extract di/dz. The signal is converted to its natural logarithm form, and the feedback loop compares this value to a reference 1n(Rdi/dz) set-point. A PI controller K(s) adjusts u to minimize the error. Notch filters are used to attenuate harmonic content, as shown at the output of the LIA. This configuration allows closed-loop regulation of di/dz during scanning operations.

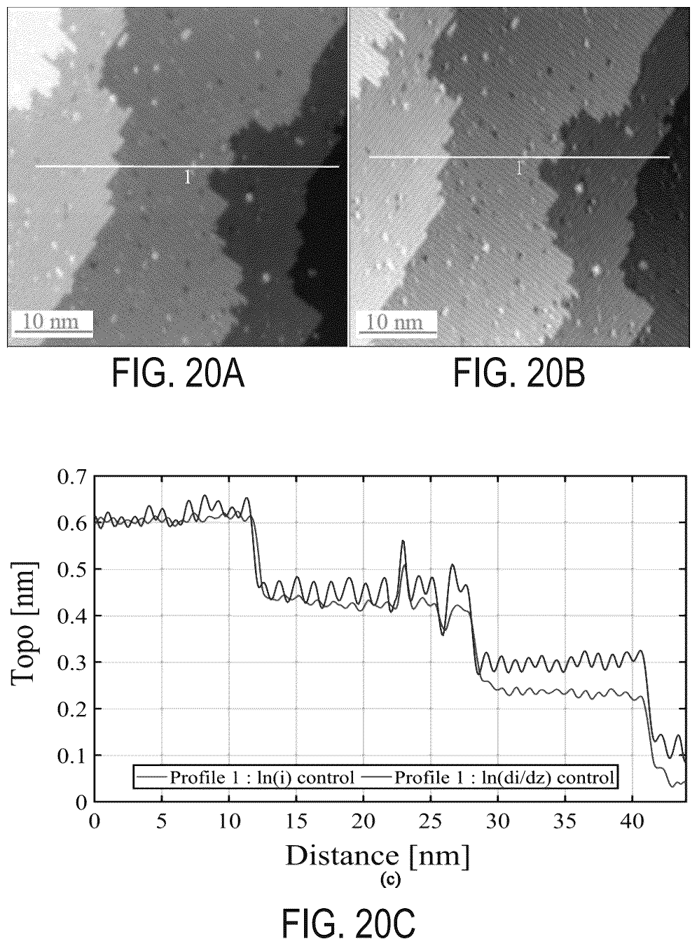

FIG. 19 presents experimental measurements comparing feedback performance in conventional constant-current and di/dz-based control modes. Panel (a) shows the topography signal, panel (b) shows the tunneling current, and panel (c) shows 1n(Rdi/dz). The system operates in constant 1n(Ri) mode until approximately 62.5 seconds, after which control is switched to the 1n(Rdi/dz) feedback loop. The transition includes a one-second interval for set-point adjustment. The plots demonstrate continuous, stable scanning and show distinct differences in signal behavior between the two feedback configurations.

### C. Example Constant Di/Dz Imaging

Once the feedback loop is closed on 1n(Rdi/dz), the STM system can be configured to raster the tungsten (W) tip across the surface of the sample along the X-Y plane. Topographic information can be generated based on control signals used to actuate the piezoelectric tube scanner. A series of experiments was conducted using various STM tips, scanner configurations, and sample surfaces to evaluate the imaging performance of the described feedback loop.

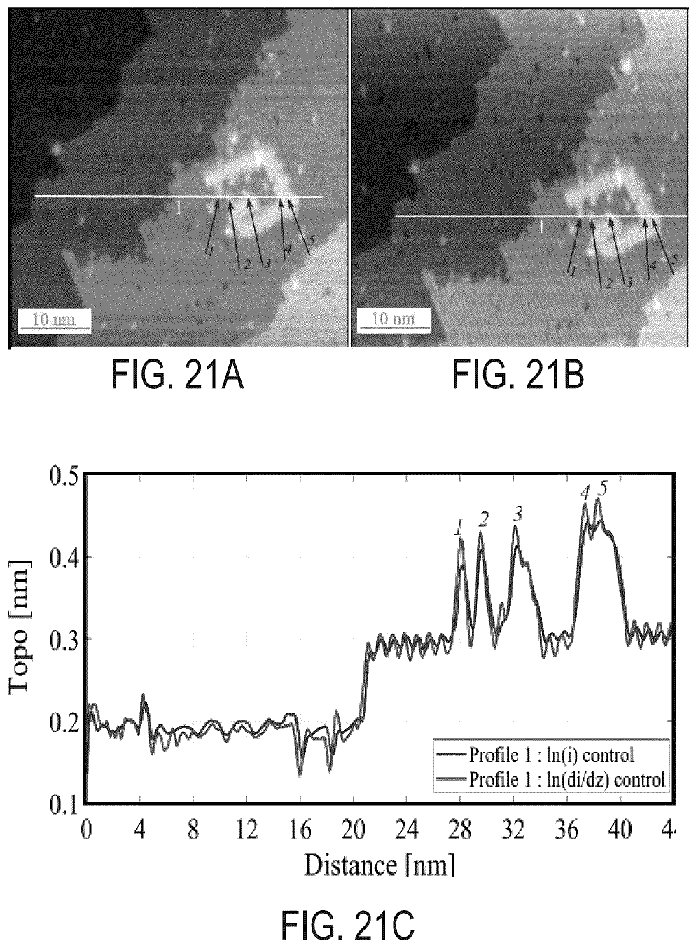

FIGS. 20A and 20B present a comparative analysis of images acquired using conventional constant 1n(Ri) feedback and constant 1n(Rdi/dz) feedback under similar experimental conditions. In FIG. 20A, the feedback loop is closed on 1n(Ri), while FIG. 20B shows the same region imaged with the loop closed on 1n(Rdi/dz). The sample in both cases is a hydrogen-passivated Si(100)−2×1 surface. The image in FIG. 20B reveals improved resolution of dimer rows, particularly at the step edges oriented along the Sb direction, where dimer rows are orthogonal to the step. Profile 1 is drawn across corresponding sample areas in both images.

FIG. 20C illustrates Profile 1 extracted from the imaging regions shown in FIGS. 20A and 20B, comparing topography data acquired using conventional 1n(Ri) feedback and 1n(Rdi/dz) feedback under similar conditions. The profile spans a region that includes several step edges and surface terraces. As shown, the trace corresponding to 1n(Rdi/dz) control exhibits enhanced peak-to-valley contrast and greater modulation amplitude across both flat regions and edge transitions. This behavior is consistent with increased sensitivity to local topographic variations observed under di/dz-based feedback, particularly in regions with subtle structural features or height discontinuities. The imaging set-point for the di/dz-based controller was determined based on prior discussion.

Enhanced resolution of dimer rows may be evident at step edges oriented along the Sb direction, where the rows are orthogonal to the step. Under constant-current feedback, features at such locations may appear blurred or spatially averaged. In contrast, feedback control based on 1n(di/dz) can enable more distinct resolution of individual dimers at and near the step edges, confirming the loop's sensitivity to fine vertical topography and localized structural discontinuities.

Further experiments were performed in conditions where the STM tip exhibited mild instability or frequent changes. These conditions enabled an assessment of the described feedback loop's stability and sensitivity to surface features. Spiral lithography was performed using the conventional 1n(Ri) loop to create dangling bonds. The resulting patterns were then imaged using both feedback modes.

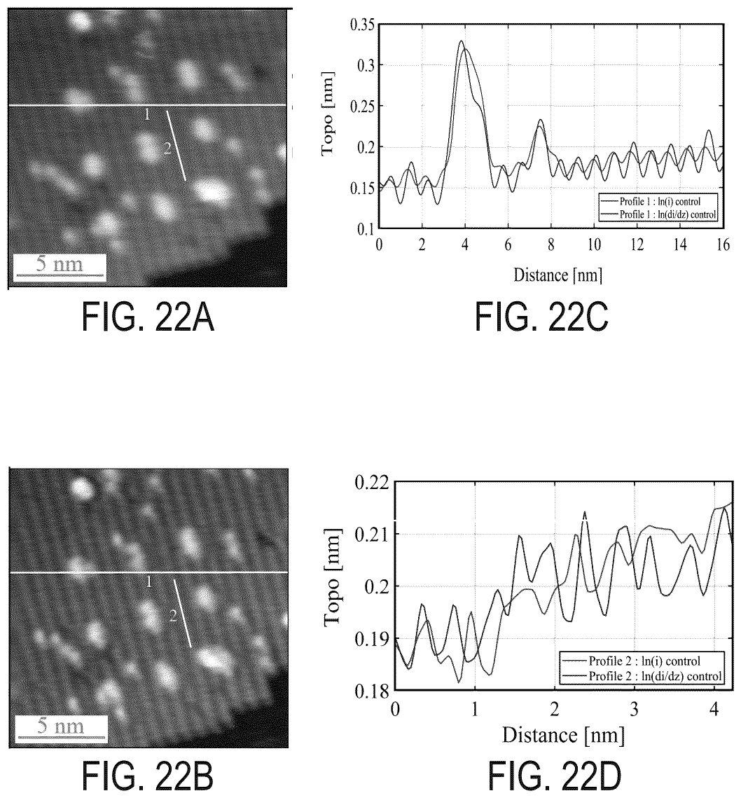

FIGS. 21A-21C illustrate a comparative evaluation of STM imaging under conditions that may include tip instability or surface feature variability. FIG. 21A presents an image acquired while operating with feedback closed on 1n(Ri), and FIG. 21B shows the same sample region imaged with feedback closed on 1n(Rdi/dz). Visual inspection of the images indicates that 1n(Rdi/dz) control may yield enhanced contrast across dimer rows and improved visibility of localized features. Arrows 1 through 3 mark surface elements observable in both images but with greater clarity in FIG. 21B. Arrows 4 and 5 highlight features that appear as merged or blurred in FIG. 21A but are more distinctly resolved as discrete dimer structures in FIG. 21B. FIG. 21C illustrates Profile 1 extracted from the image region, plotted for both feedback modes. The trace acquired under 1n(Rdi/dz) feedback exhibits increased modulation and peak definition, suggesting greater responsiveness to fine variations in topography. These observations are quantified in FIG. 21C, where Profile 1 (plotted across both images) shows that 1n(Rdi/dz) feedback enables more precise mapping of individual surface features, even under tip instability.

Additional high-resolution imaging experiments were performed by zooming in on the patterned region to confirm the enhanced performance observed with the described feedback method. The region imaged consisted of a 16 nm×16 nm area containing an array of 3×3 lithographically defined dots.

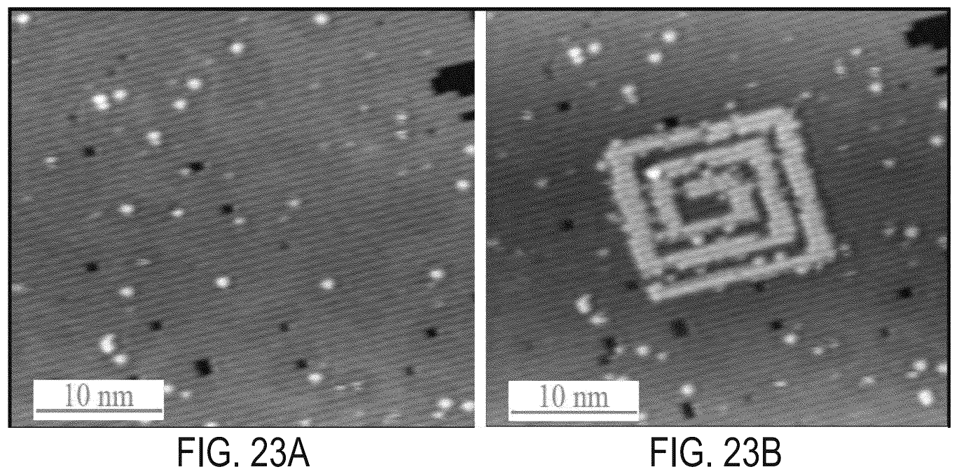

FIGS. 22A-22D illustrate comparative imaging results acquired using two different STM feedback strategies. FIG. 22A presents a topographic image acquired under constant-current feedback closed on 1n(Ri), and FIG. 22B shows the corresponding region imaged under feedback control based on 1n(Rdi/dz). Two profile lines are drawn across both images: Profile 1 spans across dimer rows, while Profile 2 follows along the dimer row direction. FIG. 22C presents Profile 1, which indicates enhanced contrast and clearer dimer row resolution in the 1n(Rdi/dz) configuration relative to the constant current mode. FIG. 22D shows Profile 2, where the image obtained with constant-current control does not fully resolve individual dimer features. In contrast, the 1n(Rdi/dz) feedback image exhibits 11 distinct peaks corresponding to individual dimers over a length of approximately 4.224 nm, in alignment with expected surface geometry.

These comparative results indicate that the described 1n(Rdi/dz) feedback loop may enable enhanced resolution of atomic-scale surface features, particularly in the presence of tip variation or instability. Imaging fidelity is observed to improve across multiple experimental conditions, scanner configurations, and lithographically modified surfaces.

### D. Example Constant Di/Dz Lithography

Hydrogen depassivation lithography (HDL) can operate in either a field emission (FE) mode or an atomically precise (AP) mode depending on applied bias voltage. When the STM system operates at bias voltages above approximately 7 V, depassivation can occur through direct excitation of Si—H bonds, referred to as FE mode. FE-mode lithography typically produces line widths on the order of approximately 4-5 nm and may exhibit edge roughness due to partial depassivation. At bias voltages below approximately 4.5 V, depassivation may proceed in AP mode, where higher tunneling currents can result in line widths of approximately 0.768 nm with atomically sharp boundaries. Although the yield associated with AP mode is often lower than FE mode, AP mode lithography can offer superior atomic-scale precision. Linewidth characteristics may vary depending on tip geometry, applied bias, and line dose, and as such, the constant 1n(Rdi/dz) feedback loop is evaluated under AP mode conditions.

XY-plane drift in the piezotube scanner is compensated prior to lithography using iterative lattice-aligned scans and drift correction procedures implemented through Scanz™ software. Following drift correction, the STM system performs a topography scan to map the lattice structure of the sample. A lithography trajectory is then defined and rastered by the STM tip in accordance with the mapped lattice, with tunneling parameters adjusted for hydrogen desorption while z-axis feedback remains closed on 1n(Rdi/dz). Electron tunneling provides energy to displace hydrogen atoms from selected locations along the scan path, generating lines of exposed silicon with dangling bonds.

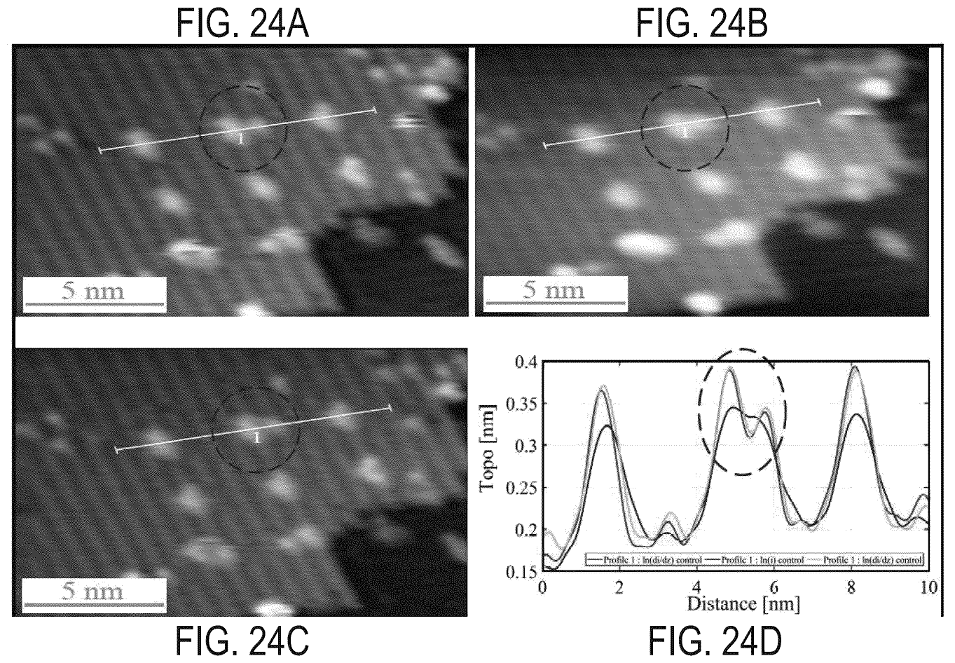

FIGS. 23A and 23B illustrate an example of spiral lithography performed using constant 1n(Rdi/dz) feedback control. FIG. 23A shows the scanned region prior to lithography, and FIG. 23B shows the resulting spiral lithography pattern acquired with a bias voltage of approximately 4.0 V, a set-point of approximately 4.0 nA/nm, and a writing speed of approximately 10 nm/sec. These lithography parameters are aligned with those used in conventional STM AP-mode patterning. The resulting pattern is approximately two dimer rows wide along the dimer axis and three dimer rows wide in the perpendicular direction. Feature definition indicates the described feedback control method supports atomic-scale lithography resolution. Lowering the bias voltage and optimizing tunneling parameters may enable formation of single-dimer-row features, depending on tip condition.

Additional lithography was performed to evaluate spatial resolution of dot patterns under constant 1n(Rdi/dz) control. A 3×3 array of dots was created on a Si(100)−2×1:H surface using the described feedback method. Each dot in the array occupied approximately two dimer rows. For comparison, an identical array was created using conventional feedback control closed on 1n(Ri), as previously shown in FIG. 22A.

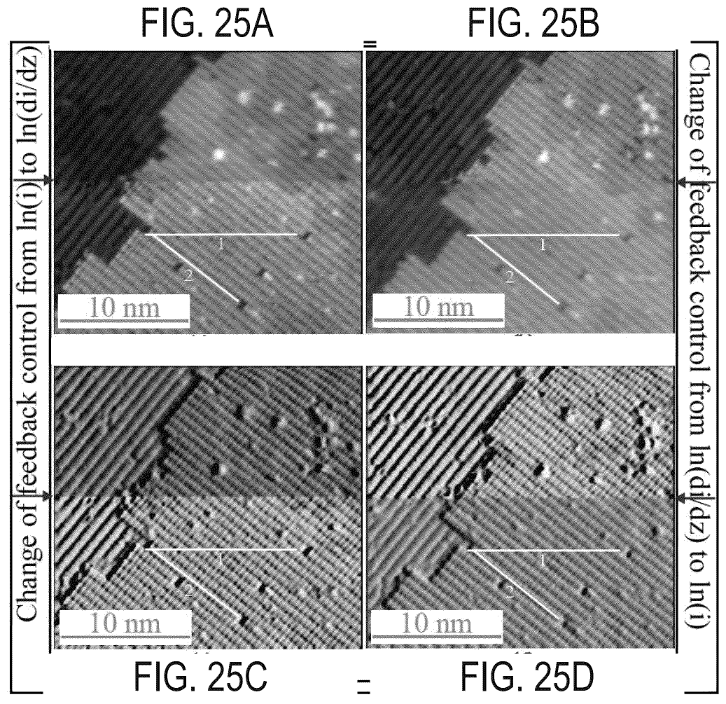

FIGS. 24A-24C present example image data from repeated scans of a lithographically patterned region acquired under different feedback configurations. FIG. 24A shows the patterned region imaged using constant 1n(R·di/dz) feedback. FIG. 24B shows the same region imaged under constant 1n(R·i) feedback. FIG. 24C presents a subsequent scan of the same region after returning to 1n(R·di/dz) control. In each image, a common profile line is drawn across a selected surface structure, which is further highlighted using a dashed blue circle to denote the area of interest for topographic comparison.

FIG. 24D illustrates Profile 1 extracted from each of the three image sets shown in FIGS. 24A-24C. In the profile associated with FIG. 24A, two adjacent peaks are observed, corresponding to two closely spaced dangling bonds. The intensity and spacing of the peaks may suggest the presence of either a double-dangling bond or a pair of distinct, proximate single-dangling bonds. In the profile from FIG. 24B, only one broad peak is visible, which may reflect reduced feature resolution under conventional 1n(R·i) feedback. In the profile corresponding to FIG. 24C, the two distinct peaks reappear, with one peak exhibiting greater intensity than the other. These observations are visually corroborated in FIG. 24C, which shows one dominant bright feature and a nearby, fainter contrast point aligned with the topographic profile.

FIGS. 24A-24D collectively illustrate that feedback control based on 1n(R·di/dz) may enable enhanced spatial discrimination of surface features, including those associated with atomic-scale lithographic structures. Under comparable tip and imaging conditions, the described feedback approach supports improved feature resolution and greater sensitivity to localized variations relative to constant-current control schemes.

### Comparing Ln(Rdi/Dz) and Ln(Ri) Feedback Mode Phenomenon

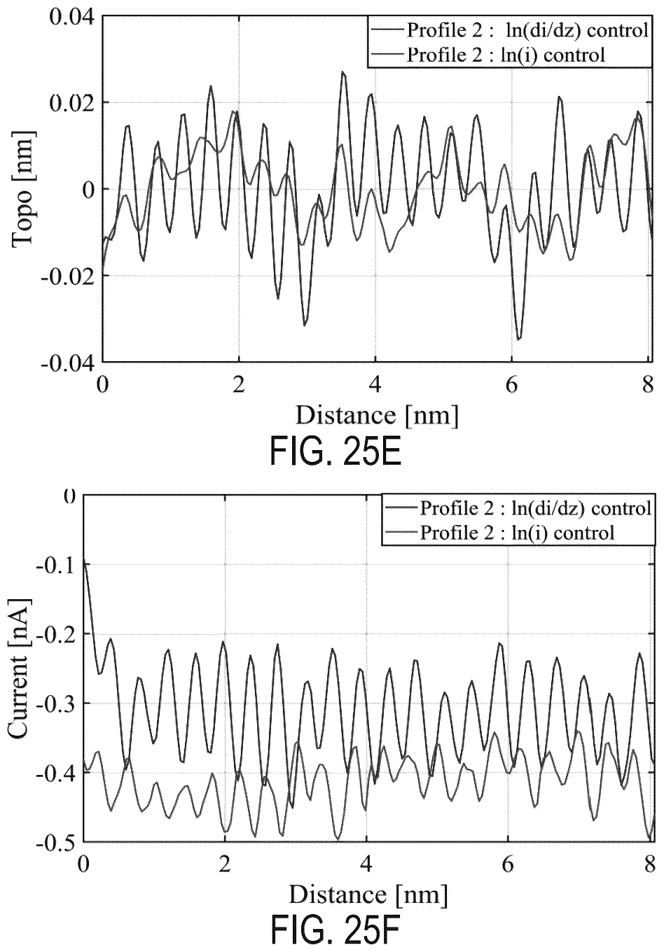

FIGS. 25A-25F illustrate comparative imaging results acquired while transitioning between a feedback control loop closed on 1n(Ri) and a feedback control loop closed on 1n(Rdi/dz), under consistent tip and sample conditions. The experiment was designed to isolate feedback-loop-dependent imaging behavior while reducing potential influences from changes in tip geometry or surface interaction.

A first set of topography and filtered tunneling current images was acquired while the control loop was switched from 1n(Ri) to 1n(Rdi/dz). FIG. 25A shows the resulting topography image, and FIG. 25C shows the corresponding filtered tunneling current. During this transition, the feedback set-point in 1n(Ri) mode was approximately 0.5 nA, and the set-point in 1n(Rdi/dz) mode was defined based on the measured di/dz value prior to switching.

A second set of images was acquired by reversing the transition—from 1n(Rdi/dz) back to 1n(Ri). The associated topography and tunneling current images are shown in FIG. 25B and FIG. 25D, respectively. Arrows within FIGS. 25A-25D denote the moment of feedback loop switching. Tip condition remained substantially constant throughout the experiment, enabling direct assessment of feedback loop effects.

In FIG. 25A, contrast enhancement and improved resolution of individual dimer features are observed in the lower portion of the image, which corresponds to operation under 1n(Rdi/dz) control. FIG. 25B similarly shows retained contrast in the upper portion of the image, associated with prior 1n(Rdi/dz) operation. These observations suggest that the 1n(Rdi/dz) feedback loop can enable improved imaging sensitivity relative to 1n(Ri) control, under comparable operating conditions.

Two profile lines were drawn for each image: Profile 1 was aligned across dimer rows, and Profile 2 was aligned along dimer rows. Analysis of Profile 2 in FIG. 25A indicates approximately 21 resolved dimer peaks, while the same profile line in FIG. 25B reveals reduced resolution under 1n(Ri) control. These differences can, in some cases, be attributed to increased tip sensitivity to vertical surface variations when operating in constant 1n(Rdi/dz) mode.

FIG. 25E presents a topography profile comparison of Profile 2, scaled and overlaid to emphasize contrast variation. The 1n(Rdi/dz) feedback loop exhibits a larger modulation range, indicating enhanced height discrimination.

FIG. 25F shows the corresponding tunneling current profiles derived from Profile 2 in FIGS. 25C and 25D. A decrease in average current from approximately −0.41 nA in 1n(Ri) mode to approximately −0.31 nA in 1n(Rdi/dz) mode is observed, suggesting a corresponding increase in tip-sample distance. This behavior is consistent with the control loop suppressing electronic output disturbances such as 1n((−1.025√ωf(σ, V_{b}))) as defined in the first term of Equation 9. Similar current behavior is also observed in Profile 1.

These experimental results indicate that the feedback loop closed on 1n(Rdi/dz) may provide improved contrast, reduced electronic disturbance sensitivity, and increased spatial resolution in STM imaging scenarios. Further, operation in 1n(Rdi/dz) mode may enable the controller to operate with reduced actuation amplitude due to higher average tip-sample distance and decreased influence from surface electronic properties.

### CONCLUSION

A STM technique has been developed that employs feedback control based on the natural logarithm of the differential tunneling current with respect to vertical tip displacement, 1n(Rdi/dz). This method involves superimposing a high-frequency sinusoidal modulation on the controller output, extracting the amplitude of the resulting tunneling current via a lock-in amplifier, and maintaining a substantially constant 1n(Rdi/dz) value throughout raster scanning using a proportional-integral controller.

Experimental results acquired across multiple STM platforms, sample preparations, and tip configurations demonstrate that the 1n(Rdi/dz) feedback mode may offer enhanced contrast, increased dimer-level resolution, and improved stability in both imaging and lithography applications when compared with conventional 1n(Ri)-based control. Comparative current profiles indicate that the system maintains a higher tip-sample distance under 1n(Rdi/dz) feedback, potentially reducing controller effort and enabling suppression of electronic disturbance contributions during scanning.

The described control loop is compatible with existing STM architectures and may be suitable for implementation in high-throughput, multi-tip STM platforms, including MEMS-based hydrogen depassivation lithography arrays. Independent feedback control and signal multiplexing capabilities can, in some cases, allow parallel tip operation without requiring proportional increases in hardware complexity.

The 1n(Rdi/dz) feedback loop may therefore serve as an effective alternative to conventional STM feedback strategies, supporting improved resolution, increased robustness to tip disturbance, and scalable control architectures for advanced nanoscale imaging and patterning.

Example Feedback Control Loop for Single-Tip STM System Using 1n(di/dz) Regulation

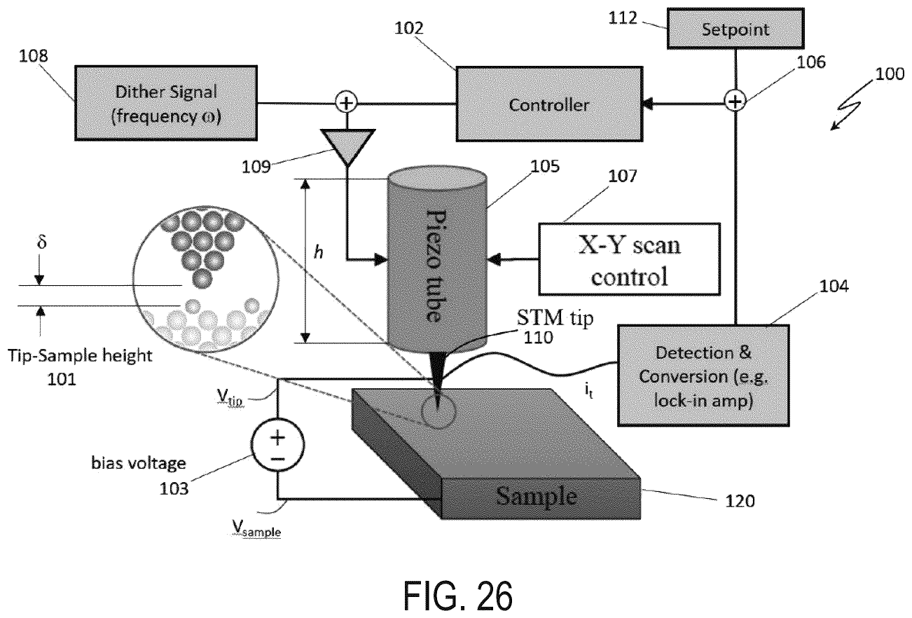

FIG. 26 illustrates an example STM system 100 configured to operate under feedback control based on a logarithmic differential tunneling signal, in accordance with certain embodiments. The STM system 100 includes a z-axis positioner 105 mechanically coupled to an STM tip 110 and further includes X-Y scan control module 107 configured to raster the STM tip 110 across a sample surface 200 along a defined scanning path.

The STM tip 110 is biased relative to the sample surface 200 using a bias voltage source 103 that establishes a voltage difference between the tip and the sample. The vertical distance between the STM tip 110 and the sample surface 200 defines a tip-sample height δ 101, which may vary dynamically based on surface topography h.

Tunneling current generated between the STM tip 110 and the sample 200 is provided to a detection and conversion module 104. In some embodiments, the detection and conversion module 104 comprises a lock-in amplifier configured to extract the amplitude of the tunneling current at a modulation frequency ω. The output of module 104 corresponds to a voltage signal proportional to 1n(di/dz), where i denotes the tunneling current and z represents vertical displacement.

The output of detection and conversion module 104 is provided to a summing node 106, where it is compared to a predefined setpoint signal 120. The resulting error signal is supplied to a controller 102, which may include a proportional-integral (PI) control structure. The controller 102 generates a control voltage output based at least in part on the difference between the measured 1n(di/dz) signal and the setpoint 120.

A dither signal generator 108 produces a sinusoidal modulation signal at frequency ω. This dither signal is summed with the controller output using summing amplifier 109 to produce a combined signal that is delivered to the z-axis positioner 105. The z-axis positioner 105 adjusts the tip-sample height δ based on the combined control and dither signals. In some embodiments, the z-axis positioner 105 comprises a piezoelectric actuator, such as a tube-type piezoelectric scanner.

During operation, the controller 102 regulates the vertical position of the STM tip 110 to maintain the detected 1n(di/dz) signal at the specified setpoint value. This feedback configuration enables precise control of the tip-sample spacing and supports enhanced imaging resolution and feedback stability. The X-Y scan control 107 coordinates lateral movement of the STM tip 110 during raster scanning, allowing generation of spatially resolved topography maps based on the controller output.

The system of FIG. 26 can be implemented in various STM configurations and may incorporate alternative signal processing techniques or feedback metrics, including 1n(R·di/dz), where R represents the transimpedance gain applied to the tunneling current signal prior to log conversion.

The STM system 100 may incorporate any of the features, components, control strategies, or signal processing techniques described herein, including but not limited to those introduced herein. For example, the feedback control loops shown in FIG. 26 may operate in combination with lock-in amplifier configurations, signal demodulation techniques, PI controller tuning approaches, low-pass filter selection criteria, disturbance rejection methods, and/or imaging or lithography procedures as disclosed herein. In some cases, the single-tip configuration of FIG. 26 may be implemented with dynamic gain models, system identification processes, or hydrogen depassivation lithography routines as described herein.

### Example Single-Tip STM System Utilizing Di/Dz Feedback

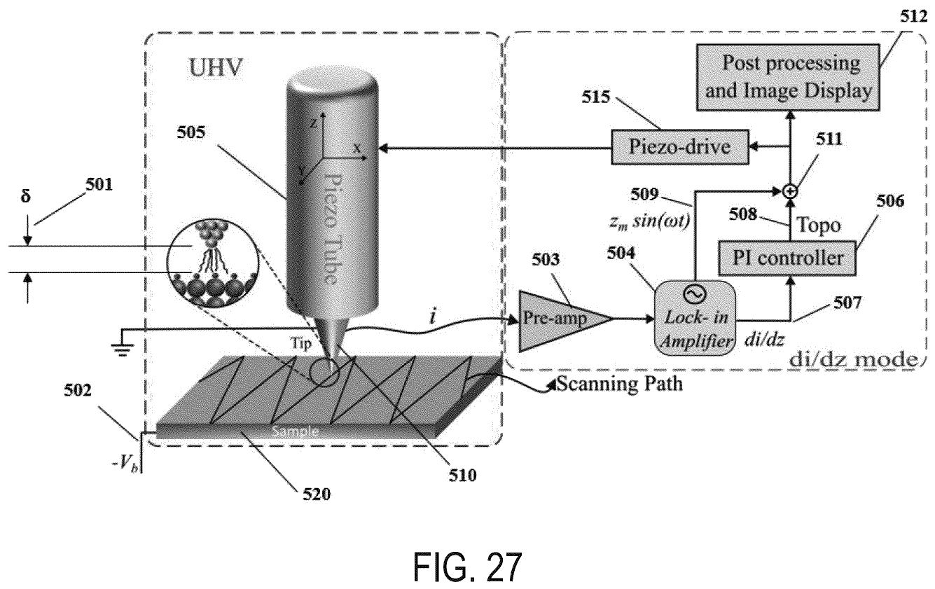

FIG. 27 illustrates an example single-tip STM system 500 configured to operate under di/dz-based feedback control. The STM system 500 includes a z-axis positioner 505, connected to an STM tip 510, and an X-Y scan control (not shown) configured to raster the STM tip 510 across a defined scanning path over a sample 520 along an X-Y plane that is substantially perpendicular to the z-axis. The z-axis positioner 505 is implemented using a piezoelectric tube in the depicted embodiment, although other actuator types may be used in alternative configurations.

The STM tip 510 is operated at a bias voltage 502 with respect to the sample 520 to induce a tunneling current i. The tip-sample distance δ 501 is defined as the vertical separation between the STM tip 510 and the sample 520 and is adjusted by the Z-axis positioner 505.

A preamplifier 503 receives the tunneling current i and generates an output signal that is supplied to a lock-in amplifier 504. The lock-in amplifier 504 is configured to detect a frequency component of the tunneling current corresponding to an applied sinusoidal signal and to generate an output voltage signal 507 that is proportional to the amplitude of that component. A signal generator is configured to apply a high-frequency sinusoidal modulation signal 509 at frequency ω to the STM system 500. This signal 509 is superimposed onto a control voltage at point 511 to induce a periodic modulation in tip position.

The output of the lock-in amplifier 504 is provided to a controller 506, which can include a PI controller configured to receive the voltage signal 507 and generate a control signal 508. The control signal 508 is combined with the modulation signal 509 to produce a summed signal that is applied to a piezo-drive 515. The piezo-drive 515 operates the Z-axis positioner 505 to adjust the vertical tip position. In some cases, the output voltage 508 is proportional to an error signal between a static set-point value for 1n(R·di/dz) and the dynamically measured 1n(R·di/dz) value.

The controller output 508 and the combined signal at point 511 may be used for post-processing and image display 520. In some cases, a topography image is generated based at least in part on the controller output voltage and the resulting summed signal, which can be recorded for further post-processing operations.

The STM system 500 may incorporate any of the features, components, control strategies, or signal processing techniques described herein, including but not limited to those introduced herein. For example, the di/dz-based feedback control loops shown in FIG. 27 may operate in combination with lock-in amplifier configurations, signal demodulation techniques, PI controller tuning approaches, low-pass filter selection criteria, disturbance rejection methods, and/or imaging or lithography procedures as disclosed herein. In some cases, the single-tip configuration of FIG. 27 may be implemented with dynamic gain models, system identification processes, or hydrogen depassivation lithography routines as described herein. These and other implementation details described herein may be selectively incorporated into or adapted for the systems depicted in FIG. 27 to support enhanced imaging resolution, tip control precision, or scalable feedback regulation across different scanning environments.

### Example Multi-Tip STM System Utilizing Di/Dz Feedback

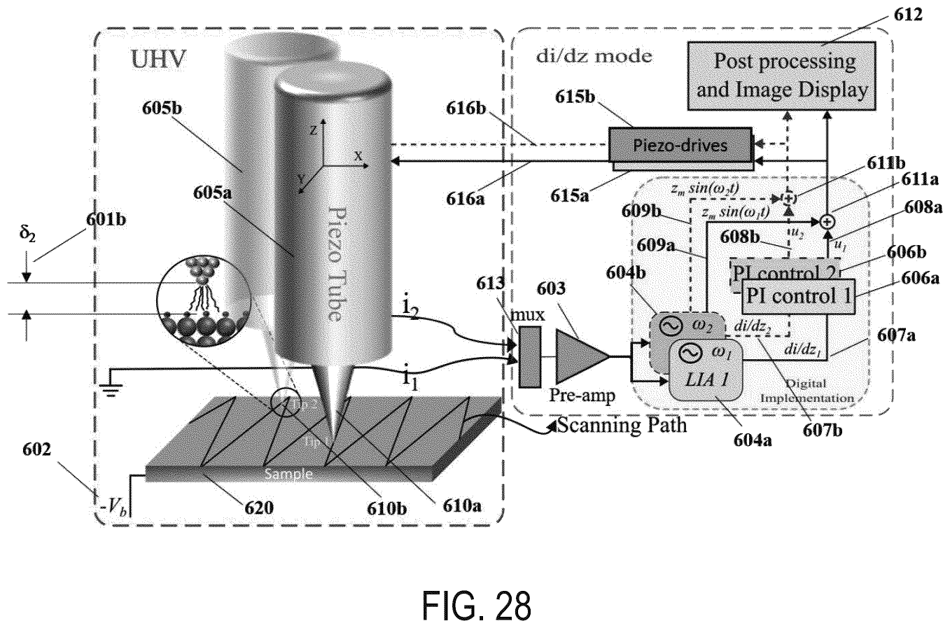

FIG. 28 illustrates an example multi-tip STM system 600 configured to perform parallel scanning using multiple STM tips 610a and 610b under respective di/dz-based feedback control. The STM system 600 includes two Z-axis positioners 605a and 605b, each operatively coupled to one of the STM tips 610a and 610b. The Z-axis positioners 605a and 605b may be implemented as piezoelectric tubes, although other actuator types may be employed.

The STM tips 610a and 610b are positioned above a sample 620 and are biased relative to the sample 620 using a common bias voltage 602. Tip-sample distances δ₁ 601a and δ₂ 601b are adjusted independently by the respective Z-axis positioners 605a and 605b. The STM system 600 further includes a multiplexer 613 configured to receive respective tunneling currents i₁ and i₂ from each tip and output a combined signal to a preamplifier 603. The preamplifier 603 provides an amplified output signal to lock-in amplifiers 604a and 604b.

The lock-in amplifiers 604a and 604b are configured to extract respective frequency components associated with high-frequency modulation signals 609a and 609b at distinct modulation frequencies ωᵢ and ω₂, respectively. Each lock-in amplifier generates an output voltage signal 607a or 607b proportional to the corresponding frequency component. In some cases, each lock-in amplifier 604a, 604b may also generate its respective sinusoidal modulation signal 609a, 609b.

Output voltage signals 607a and 607b are provided to respective controllers 606a and 606b. Each controller includes a PI controller configured to generate control output signals 608a and 608b. The output signals 608a and 608b are summed with their corresponding modulation signals at points 611a and 611b and then provided to piezo-drives 615a and 615b. The piezo-drives 615a and 615b operate the z-axis positioners 605a and 605b to control tip displacement based at least in part on the error between the static set-point and the measured 1n(R·di/dz) signal for each tip.

The summed control signals at points 611a and 611b may also be used for post-processing and image display 620. In some cases, topographic image data is generated based on the controller outputs 608a, 608b and/or the summed signals at points 611a, 611b, which may be stored or processed further.

In some cases, each controller 606a, 606b is independently configured to close a control feedback loop for each STM tip based on its associated 1n(R·di/dz) signal. This configuration allows each STM tip to operate at a unique modulation frequency within a designated frequency range (e.g., ω₁, ω₂, . . . , ω_{N}), while enabling the use of a shared preamplifier 603. Such configurations may reduce system size, power consumption, and hardware complexity, particularly in multi-tip STM platforms where N is greater than two.

The STM system 600 may be generalized to include N scanning tips, N controllers, N lock-in amplifiers, and N piezo-drives, each operating at a distinct frequency and closing an independent feedback loop for respective 1n(R·di/dz) signals. The elements described in connection with the example of FIG. 28 may be scaled accordingly to support N-channel feedback and imaging.

The STM system 600 may incorporate any of the features, components, control strategies, or signal processing techniques described herein, including but not limited to those introduced herein. For example, the di/dz-based feedback control loops shown in FIG. 28 may operate in combination with lock-in amplifier configurations, signal demodulation techniques, PI controller tuning approaches, low-pass filter selection criteria, disturbance rejection methods, and/or imaging or lithography procedures as disclosed herein. In some cases, the single-tip configuration of FIG. 28 may be implemented with dynamic gain models, system identification processes, or hydrogen depassivation lithography routines as described herein. These and other implementation details described herein may be selectively incorporated into or adapted for the systems depicted in FIG. 28 to support enhanced imaging resolution, tip control precision, or scalable feedback regulation across different scanning environments.

### Terminology

It is understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this present disclosure may include, additional to its essential features described herein, one or more features as described herein from each other embodiment of the present disclosure disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in various combinations, one or more features from a claimed combination can, in some cases, be excised from the combination, and the combination may be claimed as a subcombination or variation of a sub combination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some cases, the actual steps taken in the processes illustrated and/or disclosed may differ from those shown in the figures. In at least some examples, the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey cases include, while other embodiments do not include, features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain cases require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A scanning probe system comprising:
a probe configured to establish a tunneling current with a surface in response to a bias voltage applied between the probe and the surface;
an actuator configured to adjust a separation between the probe and the surface;
a controller configured to generate a control signal for the actuator;
a modulation generator configured to apply a modulation signal to the control signal;
a current sensing circuit configured to produce a tunneling signal representative of the tunneling current;
a demodulation circuit configured to extract a derivative signal based at least in part on the tunneling signal and the modulation signal, wherein the derivative signal corresponds to a time-varying component indicative of a rate of change of the tunneling current with respect to a separation between the probe and the surface;
a feedback processor configured to compute a control metric based at least in part on the derivative signal;
wherein the controller is configured to update the control signal based at least in part on a difference between the control metric and a defined setpoint;
wherein the control signal is configured to regulate the separation between the probe and the surface such that the control metric remains substantially constant during scanning.

2. The system of claim 1, wherein the derivative signal comprises a signal representative of a natural logarithm of a product of a transimpedance gain and a derivative of the tunneling current with respect to the separation between the probe and the surface.

3. The system of claim 1, wherein the modulation generator is configured to apply a sinusoidal modulation to the control signal at a frequency selected to be outside a control bandwidth associated with the feedback processor.

4. The system of claim 1, wherein the demodulation circuit comprises a lock-in amplifier configured to extract a frequency component of the tunneling signal corresponding to the modulation signal.

5. The system of claim 1, wherein the feedback processor comprises a proportional-integral controller configured to generate the control signal based on an error between the control metric and the defined setpoint.

6. The system of claim 1, wherein the current sensing circuit comprises a transimpedance amplifier configured to convert the tunneling current into a voltage signal prior to demodulation.

7. The system of claim 1, wherein the feedback processor is configured to compute the control metric based on a magnitude of the derivative signal.

8. The system of claim 1, wherein the probe is configured to be rastered along a lateral scanning path while the actuator adjusts the separation between the probe and the surface based on the control signal.

9. The system of claim 1, wherein the probe comprises a single probe, the actuator comprises a single actuator configured to vertically displace the probe relative to the surface, and the controller is further configured to raster the probe laterally across the surface during scanning, wherein the control signal is used to generate a topography signal based at least in part on regulation of the separation between the probe and the surface.

10. The system of claim 1, wherein:
the probe comprises a plurality of probes, each configured to establish a respective tunneling current with the surface;
the actuator comprises a plurality of actuators, each configured to adjust a respective separation between the probe and the surface;
the controller comprises a plurality of controllers, each configured to generate a respective control signal for a corresponding actuator;
the modulation generator comprises a plurality of modulation generators, each configured to apply a modulation signal at a distinct frequency to a respective control signal;
the current sensing circuit is configured to receive a combined tunneling current from the plurality of probes; and
the demodulation circuit comprises a plurality of lock-in amplifiers, each configured to extract a respective derivative signal associated with a corresponding modulation frequency; and
the feedback processor comprises a plurality of feedback processors, each configured to compute a respective control metric based on the respective derivative signal and update the respective control signal based at least in part on a difference between the control metric and a corresponding defined setpoint.

11. A method for operating a scanning probe system, the method comprising:
applying a modulation signal to a control signal associated with an actuator configured to adjust a separation between a probe and a surface, wherein the modulation signal induces a displacement of the probe relative to the surface;
generating a tunneling signal representative of a tunneling current induced between the probe and the surface, the tunneling current being responsive to probe displacement resulting from application of the modulation signal;
obtaining a derivative signal based at least in part on the tunneling signal and the modulation signal, wherein the derivative signal is indicative of a rate of change of the tunneling current with respect to the separation between the probe and the surface;
determining a feedback metric based at least in part on the derivative signal; and
adjusting the control signal based at least in part on a difference between the feedback metric and a reference value.

12. The method of claim 11, wherein the control signal regulates the separation between the probe and the surface such that the feedback metric remains substantially constant during scanning.

13. The method of claim 11, wherein the modulation signal comprises a sinusoidal waveform applied at a frequency selected to be greater than a closed-loop control bandwidth of the scanning probe system and less than a mechanical resonance frequency associated with the actuator.

14. The method of claim 11, wherein generating the tunneling signal comprises amplifying the tunneling current using a transimpedance amplifier to convert the tunneling current into a voltage signal prior to obtaining the derivative signal.

15. The method of claim 11, wherein obtaining the derivative signal comprises:
demodulating the tunneling signal at a frequency of the modulation signal using a lock-in amplifier; and
extracting an amplitude component representative of the rate of change of the tunneling current with respect to the separation between the probe and the surface.

16. The method of claim 11, wherein determining the feedback metric comprises applying a natural logarithm to a product of a transimpedance gain and the derivative signal, wherein the feedback metric is proportional to 1n(Rdi/dz), where R is the transimpedance gain and di/dz is a derivative of the tunneling current with respect to the separation between the probe and the surface.

17. The method of claim 11, wherein the feedback metric is proportional to a rate of change of the tunneling current with respect to the separation between the probe and the surface.

18. The method of claim 11, wherein adjusting the control signal comprises:
generating an error signal based on a difference between the feedback metric and the reference value; and
applying a proportional-integral controller to generate the adjusted control signal based on the error signal.

19. The method of claim 11, further comprising raster scanning the probe along a defined lateral path while maintaining the control signal such that the separation between the probe and the surface varies to preserve the feedback metric at or near the reference value.

20. The method of claim 11, wherein the scanning probe system comprises a plurality of probes, and the method further comprises:
applying distinct modulation signals at different respective frequencies to a corresponding set of control signals associated with actuators for each of the plurality of probes;
independently generating, for each of the plurality of probes, a tunneling signal and a corresponding derivative signal;
independently determining a feedback metric for each of the plurality of probes based on the corresponding derivative signal; and
independently adjusting each control signal based on a respective difference between the corresponding feedback metric and a reference value.
